(19) United States
(12) Patent Application Publication
(10) Pub. No.: US 2025/0191452 A1
(43) Pub. Date: Jun. 12, 2025

(54) Context-Based User Interface

(71) Applicant: Google LLC, Mountain View, CA (US)

(72) Inventors: Ramprasad Sedouram, Varthur (IN); George Wesley Hines, Los Gatos, CA (US); Marci Meingast, San Francisco, CA (US); Matthew Wagner, Mountain View, CA (US); Sung Kyun Bai, San Jose, CA (US); Adam Cutbill, Palo Alto, CA (US)

(73) Assignee: Google LLC, Mountain View, CA (US)

(21) Appl. No.: 18/845,344

(22) PCT Filed: May 10, 2022
(86) PCT No.: PCT/US2022/072234

§ 371 Date: Sep. 9, 2024

(51) Int. Cl. G08B 13/196; G06F 3/0485; G06F 3/0488; G06V 40/16; H04N 7/18

(52) U.S. Cl. CPC G08B 13/19682; G06F 3/0485; G06V 40/168; H04N 7/186; G06F 3/0488; G06V 2201/09

(57) ABSTRACT

The present document describes techniques for providing a context-based user interface. These techniques include an electronic device having a user interface that dynamically adapts to a context of a visitor or a type of visitor. Characteristics associated with the visitor are detected, using sensors, and used to determine a context of the visitor. The user interface is then populated with curated, customized context-based options that correspond to the context of the visitor. The context-based options represent possible reasons for the visitor's visit and are estimated based on the detected characteristics. The visitor interacts with the user interface to select an appropriate context-based option to convey their intent for visiting an occupant of a building associated with the electronic device. Then, a notification associated with the selected context-based option is provided.

### BACKGROUND

With advances in home security systems, including video-recording doorbells, a user can view a visitor outside the user's home by using an electronic device to access images of a video feed captured by a camera of the doorbell. Some home security systems can identify the visitor using image-processing techniques, including face recognition or person recognition. Identification of the visitor can be a useful feature in many cases, such as when the user is expecting a visit from a friend, family member, or delivery service. However, if the image captured by the camera (e.g., security camera, video-recording doorbell) is not reliable or if the visitor is unknown to the system, then the visitor may not be identifiable by the system to notify the user in the home, resulting in a diminished user experience.

### SUMMARY

The present document describes methods and apparatuses for providing a context-based user interface, e.g., for a doorbell. These techniques include an electronic device (e.g., video-recording doorbell) having a user interface that dynamically adapts to a context of a visitor or a type of visitor. Characteristics associated with the visitor are detected, using sensors, and used to determine a context of the visitor. The user interface is then populated with curated, customized context-based options that correspond to that context. The context-based options represent possible reasons for the visitor's visit and are estimated based on the detected characteristics. The visitor interacts with the user interface to select an appropriate context-based option to convey their intent for visiting an occupant of a building associated with the electronic device. Then, a notification associated with the selected context-based option is provided.

In some aspects, a method for providing context-based options to a guest in proximity to an electronic device associated with a structure is disclosed. The method includes determining, using one or more sensors of the electronic device, one or more characteristics of the guest and determining a context of the guest based on the one or more characteristics. The method also includes identifying, based on the determined context, a plurality of context-based options that each represent an estimated purpose for a visit by the guest (e.g., to an occupant of the structure associated with the electronic device). In addition, the method includes presenting the plurality of context-based options via a user interface displayed by a display device of the electronic device, the plurality of options being selectable by the guest to convey an intent for the guest's visit to the occupant of the structure. Also, the method includes receiving a user input from the guest selecting a context-based option from the plurality of context-based options presented via the user interface and providing a notification associated with the selected context-based option.

In aspects, an electronic device is disclosed. The electronic device includes one or more sensors configured to determine one or more characteristics of a guest visiting a structure associated with the electronic device. In addition, the electronic device includes a display device configured to present a user interface and a mechanical input device integrated with the display device. Also, the electronic device includes a processor configured to perform the method describe above. In an embodiment, the electronic device may also include a camera device configured to capture one or more images of the guest. A camera device may include at least one image sensor for capturing at least one image of a guest which may be used alone or in combination with sensor data from at least one other sensor to determine the one or more characteristics.

This summary is provided to introduce simplified concepts of context-based user interface, which are further described below in the Detailed Description. This summary is not intended to identify essential features of the claimed subject matter, nor is it intended for use in determining the scope of the claimed subject matter.

### BRIEF DESCRIPTION OF THE DRAWINGS

The details of one or more aspects of a context-based user interface are described in this document with reference to the following drawings. The same numbers are used throughout the drawings to reference like features and components:

FIG. 1A is a representative network environment in accordance with some implementations;

FIG. 1B illustrates the representative network environment in more detail;

FIG. 2A is a block diagram illustrating a representative network architecture that includes a home area network in accordance with some implementations;

FIG. 2B illustrates a representative operating environment in which a server system provides data processing for monitoring and facilitating review of events in video streams captured by cameras;

FIG. 3A is a block diagram illustrating the server system in accordance with some implementations;

FIG. 3B illustrates various data structures used by some implementations, including an event record, a user profile, a device profile, and characterization data;

FIG. 3C illustrates an example implementation of information associated with a user that is usable to provide context-based options to a guest via a wireless network device;

FIG. 4 is a block diagram illustrating a representative smart device in accordance with some implementations;

FIG. 5 illustrates a representative system architecture including video source(s), server system, and client device(s) in accordance with some implementations;

FIG. 6 is a block diagram illustrating a representative client device associated with a user account in accordance with some implementations;

FIG. 7 illustrates an example implementation of an electronic device configured for a context-based user interface in accordance with the techniques described herein;

FIG. 8 illustrates an example implementation of an apparatus providing context-based options to a guest;

FIG. 9 illustrates another example implementation of an apparatus providing context-based options to a guest;

FIG. 10 illustrates another example implementation of an apparatus providing context-based options to a guest;

FIG. 11 illustrates another example implementation of an apparatus providing context-based options to a guest;

FIG. 12 illustrates another example implementation of an apparatus providing context-based options to a guest;

FIG. 13 illustrates another example implementation of an apparatus providing context-based options to a guest;

FIG. 14 illustrates another example implementation of an apparatus providing context-based options to a guest;

FIG. 15 illustrates another example implementation of an apparatus providing context-based options to a guest;

FIG. 16 illustrates an example implementation of an apparatus providing context-based options to an occupant outside their home;

FIG. 17 illustrates another example implementation of an apparatus providing context-based options to a homeowner;

FIG. 18 illustrates an example implementation of an apparatus configured to provide context-aware notification to a guest;

FIG. 19 illustrates another example implementation of an apparatus configured to provide context-aware notifications to a guest;

FIG. 20 illustrates another example implementation of an apparatus configured to provide context-aware notifications to a guest;

FIG. 21 depicts an example method for providing context-based options to a guest; and

FIG. 22 depicts an example method of providing context-aware notifications.

### DETAILED DESCRIPTION

The present document describes techniques and apparatuses for providing a context-based user interface of an electronic device associated with a building (e.g., house, office, apartment, factory), such as a context-based doorbell user interface. The techniques described herein enable the electronic device to detect information about a guest (e.g., visitor) that provides clues as to the type of person (e.g., food courier, parcel courier, solicitor) the guest might be as well as their potential purpose for visiting. This may be helpful in situations where the type of guest is not clearly identifiable using images or video captured by a camera (e.g., security camera, doorbell camera) or audio captured by a microphone. In such cases, the techniques described herein determine a context of the guest based on the detected information and provide a dynamic user interface that is populated with customized, context-based options, which (i) are identified in real-time based on the detected information about the guest and (ii) represent possible reasons for the guest's visit. The context-based options may be more generic if the detected information is vague or the context-based options may be more specific if the detected information is more specific. Then, the guest can select one of the context-based options via the user interface to indicate their intent for visiting an occupant inside the building.

In one example, a courier is not able to correctly pronounce the occupant's name for a delivery, perhaps due to the courier not being able to speak the language of the occupant. Some couriers may not wear a uniform that indicates a brand that they represent. Some cameras may not provide a clear image of the guest. In these cases, the occupant may still wish to know at least what type of guest has arrived. In instances where the guest is a courier, it may be further beneficial for the occupant to know what type of object (e.g., food, ecommerce parcel, medicine) they are delivering. Using the techniques described herein, the guest can interact with the user interface to indicate their intent for visiting, and the occupant can be notified accordingly. In this way, the occupant can know, for example, whether a parcel is being dropped off, whether a signature is required or not, whether the guest is medical personnel, whether payment is required, etc. The context-based options displayed may be less than the number of options available (e.g., pre-stored or generated by machine-learning during operation of the electronic device). The electronic device may thus be capable of just displaying a certain number and types of context-based options automatically adapted based on the sensor data relating to the one or more characteristics of the guest. The electronic device may thus allow for determining and displaying a relatively small/reduced-compared to a total number of available options-number of automatically adapted (e.g., individualized for a guest) context-based options thereby facilitating for a guest the selection of the context-based option for sending the notification. Ease of use may thus be increased and a risk for maloperation reduced.

The techniques described herein provide an enhanced user experience by providing a dynamic user interface with context-based options that are customized for a guest to select to indicate their intent for visiting an occupant of a building. In aspects, the context-based options are determined and populated on the user interface as the guest is approaching the building or the electronic device associated with the building. The occupant can be notified, and thereby have a better understanding, of the type of guest and their intent for visiting without first having to answer the door. This may be particularly useful in situations where the guest cannot be clearly identified via images or video of the guest.

While features and concepts of the described techniques for context-based user interface can be implemented in any number of different environments, aspects are described in the context of the following examples.

### Example Environment

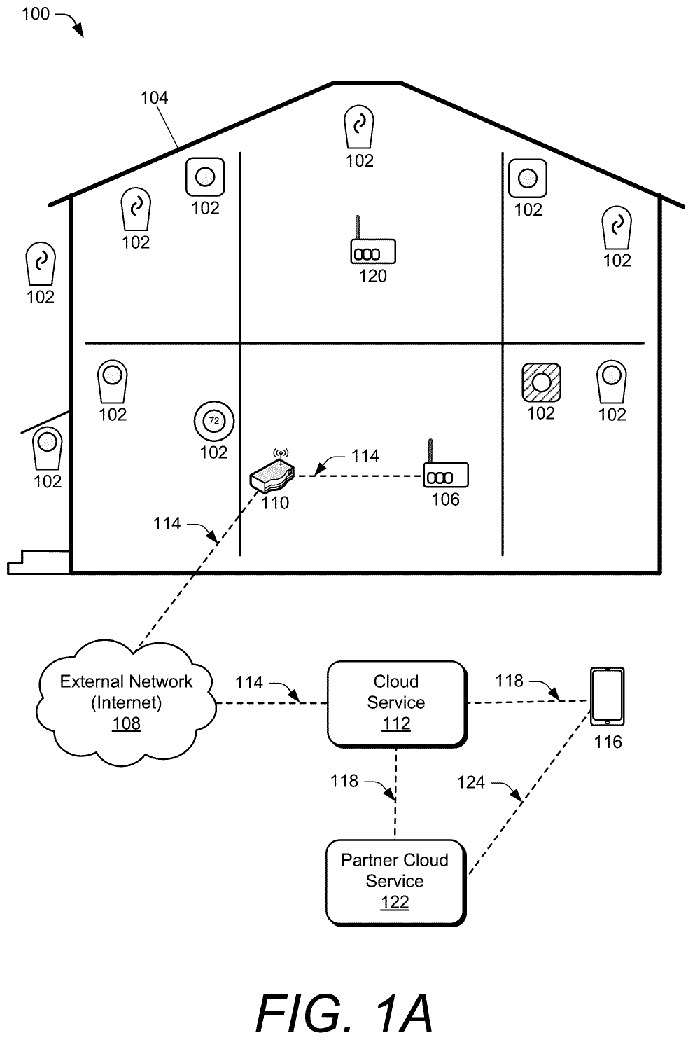

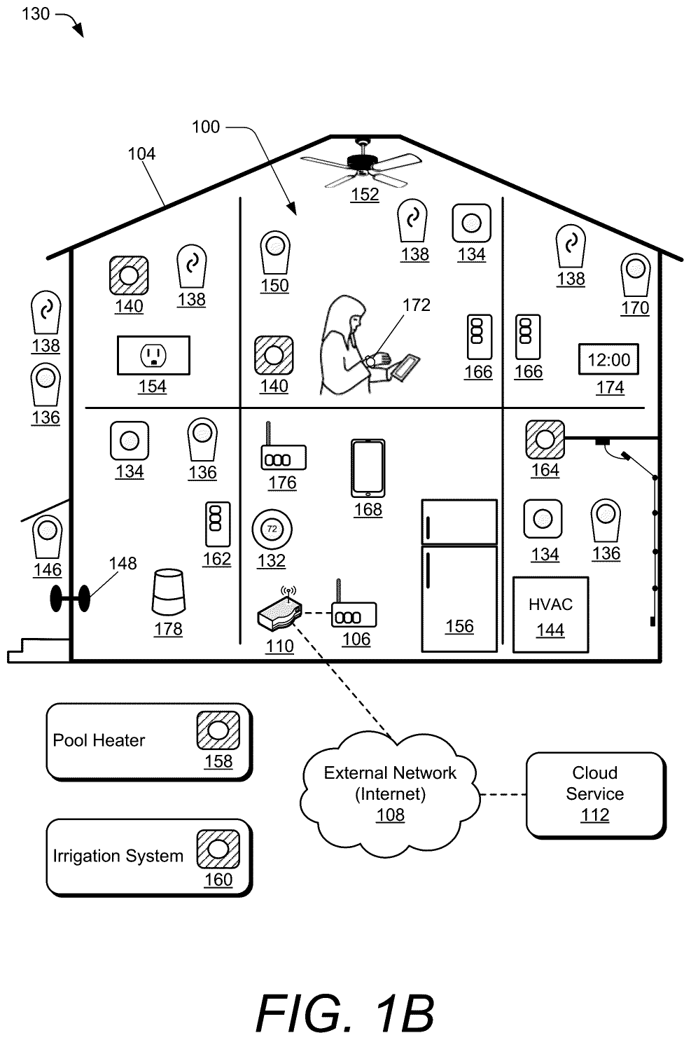

FIG. 1A illustrates an example network environment 100 (e.g., network environment) in which context-based user interface can be implemented. The network environment 100 includes a home area network (HAN). The HAN includes wireless network devices 102 (e.g., electronic devices) that are disposed about a structure 104, such as a house, and are connected by one or more wireless and/or wired network technologies, as described below. The HAN includes a border router 106 that connects the HAN to an external network 108, such as the Internet, through a home router or access point 110.

To provide user access to functions implemented using the wireless network devices 102 in the HAN, a cloud service 112 connects to the HAN via a border router 106, via a secure tunnel 114 through the external network 108 and the access point 110. The cloud service 112 facilitates communication between the HAN and internet clients 116, such as apps on mobile devices, using a web-based application programming interface (API) 118. The cloud service 112 also manages a home graph that describes connections and relationships between the wireless network devices 102, elements of the structure 104, and users. The cloud service 112 hosts controllers which orchestrate and arbitrate home automation experiences, as described in greater detail below.

The HAN may include one or more wireless network devices 102 that function as a hub 120. The hub 120 may be a general-purpose home automation hub, or an application-specific hub, such as a security hub, an energy management hub, a heating, ventilation, and air conditioning (HVAC) hub, and so forth. The functionality of a hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner Web API 124. The partner cloud service 122 may optionally or additionally provide services to internet clients 116 via the web-based API 118, the cloud service 112, and the secure tunnel 114.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in a distributed computing environment (e.g., the network environment 100). These services include, but are not limited to, real-time distributed data management and subscriptions, command-and-response control, real-time event notification, historical data logging and preservation, cryptographically controlled security groups, time synchronization, network and service pairing, and software updates.

FIG. 1B illustrates an example environment 130 in which a home area network, as described with reference to FIG. 1A, and aspects of a context-based user interface can be implemented. Generally, the environment 130 includes the home area network (HAN) implemented as part of a home or other type of structure with any number of wireless network devices (e.g., wireless network devices 102) that are configured for communication in a wireless network. For example, the wireless network devices can include a thermostat 132, hazard detectors 134 (e.g., for smoke and/or carbon monoxide), cameras 136 (e.g., indoor and outdoor), lighting units 138 (e.g., indoor and outdoor), and any other types of wireless network devices 140 that are implemented inside and/or outside of the structure 104 (e.g., in a home environment). In this example, the wireless network devices 102 can also include any of the previously described devices, such as a border router 106, as well as a mobile device (e.g., smartphone) having the internet client 116.

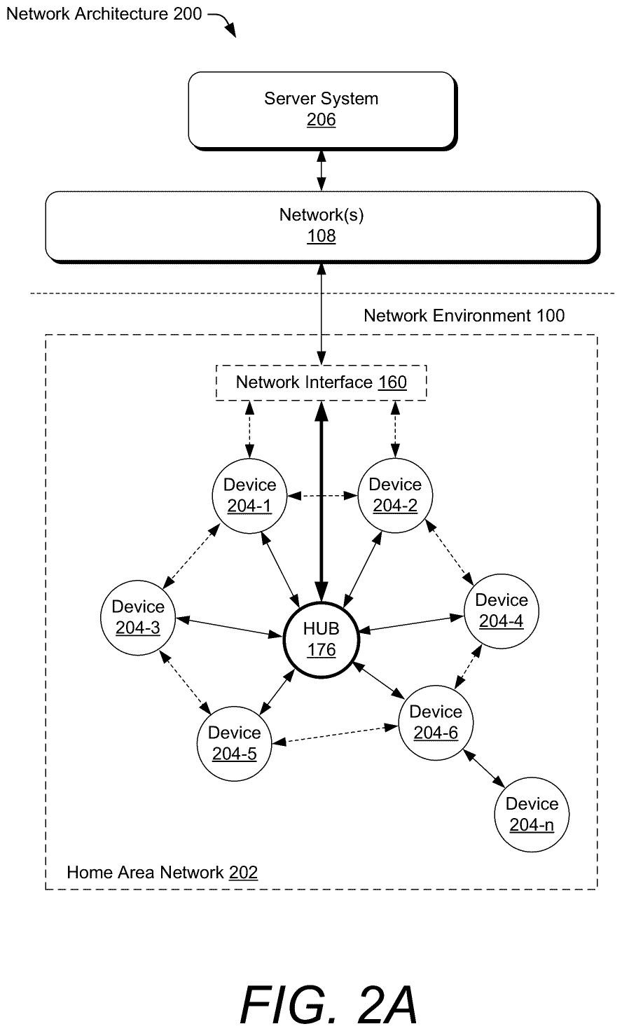

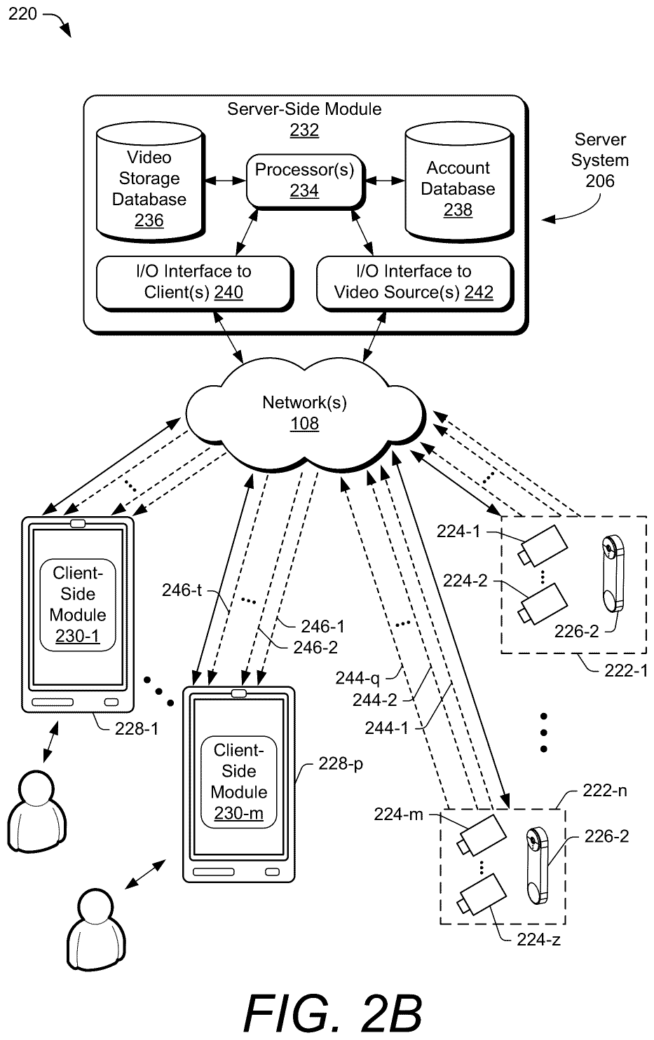

In the environment 130, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 2A.

In implementations, the thermostat 132 may include a Nest® Learning Thermostat that detects ambient climate characteristics (e.g., temperature and/or humidity) and controls an HVAC system 144 in the home environment. The learning thermostat 132 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 134 can be implemented to detect the presence of a hazardous substance or a substance indicative of a hazardous substance (e.g., smoke, fire, or carbon monoxide). In examples of wireless interconnection, a hazard detector 134 may detect the presence of smoke, indicating a fire in the structure, in which case the hazard detector that first detects the smoke can broadcast a low-power wake-up signal to all of the connected wireless network devices. The other hazard detectors 134 can then receive the broadcast wake-up signal and initiate a high-power state for hazard detection and to receive wireless communications of alert messages. Further, the lighting units 138 can receive the broadcast wake-up signal and activate in the region of the detected hazard to illuminate and identify the problem area. In another example, the lighting units 138 may activate in one illumination color to indicate a problem area or region in the structure, such as for a detected fire or break-in, and activate in a different illumination color to indicate safe regions and/or escape routes out of the structure.

In various configurations, the wireless network devices 140 can include an entryway interface device 146 that functions in coordination with a network-connected door lock system 148, and that detects and responds to a person's approach to or departure from a location, such as an outer door of the structure 104. The entryway interface device 146 can interact with the other wireless network devices based on whether someone has approached or entered the smart home environment. An entryway interface device 146 can control doorbell functionality, announce the approach or departure of a person via audio or visual means, and control settings on a security system, such as to activate or deactivate the security system when occupants come and go. The wireless network devices 140 can also include other sensors and detectors, such as to detect ambient lighting conditions, detect room-occupancy states (e.g., with an occupancy sensor 150), and control a power and/or dim state of one or more lights. In some instances, the sensors and/or detectors may also control a power state or speed of a fan, such as a ceiling fan 152. Further, the sensors and/or detectors may detect occupancy in a room or enclosure and control the supply of power to electrical outlets 154 or devices 140, such as if a room or the structure is unoccupied.

The wireless network devices 140 may also include connected appliances and/or controlled systems 156, such as refrigerators, stoves and ovens, washers, dryers, air conditioners, pool heaters 158, irrigation systems 160, security systems 162, and so forth, as well as other electronic and computing devices, such as televisions, entertainment systems, computers, intercom systems, garage-door openers 164, ceiling fans 152, control panels 166, and the like. When plugged in, an appliance, device, or system can announce itself to the home area network as described above and can be automatically integrated with the controls and devices of the home area network, such as in the home. It should be noted that the wireless network devices 140 may include devices physically located outside of the structure, but within wireless communication range, such as a device controlling a swimming pool heater 158 or an irrigation system 160.

As described above, the HAN includes a border router 106 that interfaces for communication with an external network, outside the HAN. The border router 106 connects to an access point 110, which connects to the external network 108, such as the Internet. A cloud service 112, which is connected via the external network 108, provides services related to and/or using the devices within the HAN. By way of example, the cloud service 112 can include applications for connecting end-user devices 168, such as smartphones, tablets, and the like, to devices in the home area network, processing and presenting data acquired in the HAN to end-users, linking devices in one or more HANs to user accounts of the cloud service 112, provisioning and updating devices in the HAN, and so forth. For example, a user can control the thermostat 132 and other wireless network devices in the home environment using a network-connected computer or portable device, such as a mobile phone or tablet device. Further, the wireless network devices can communicate information to any central server or cloud-computing system via the border router 106 and the access point 110. The data communications can be carried out using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, and so on).

Any of the wireless network devices in the HAN can serve as low-power and communication nodes to create the HAN in the home environment. Individual low-power nodes of the network can regularly send out messages regarding what they are sensing, and the other low-powered nodes in the environment—in addition to sending out their own messages—can repeat the messages, thereby communicating the messages from node to node (e.g., from device to device) throughout the home area network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, the occupancy sensor 150 and/or an ambient light sensor 170 can detect an occupant in a room as well as measure the ambient light, and activate the light source when the ambient light sensor 170 detects that the room is dark and when the occupancy sensor 150 detects that someone is in the room. Further, the sensor can include a low-power wireless communication chip (e.g., an Institute of Electrical and Electronics Engineers (IEEE) 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (e.g., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the home area network. In other implementations, the home area network can be used to automatically turn on and off the lighting units 138 as a person transitions from room to room in the structure. For example, the wireless network devices can detect the person's movement through the structure and communicate corresponding messages via the nodes of the home area network. Using the messages that indicate which rooms are occupied, other wireless network devices that receive the messages can activate and/or deactivate accordingly. As referred to above, the home area network can also be utilized to provide exit lighting in the event of an emergency, such as by turning on the appropriate lighting units 138 that lead to a safe exit. The lighting units 138 may also be turned on to indicate the direction along an exit route that a person should travel to safely exit the structure.

The various wireless network devices may also be implemented to integrate and communicate with wearable computing devices 172, such as may be used to identify and locate an occupant of the structure and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques can draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The wireless network devices 140 may also include a network-connected alarm clock 174 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 132 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 132 so as to pre-heat or cool the environment to a desired setting and turning on or turning off the lighting units 138.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 130 may include one or more wireless network devices that function as a hub 176. The hub 176 (e.g., hub 120) may be a general-purpose home automation hub, or an application-specific hub, such as a security hub, an energy management hub, an HVAC hub, and so forth. The functionality of a hub 176 may also be integrated into any wireless network device, such as a network-connected thermostat device or the border router 106. Hosting functionality on the hub 176 in the structure 104 can improve reliability when the user's internet connection is unreliable, can reduce latency of operations that would normally have to connect to the cloud service 112, and can satisfy system and regulatory constraints around local access between wireless network devices.

Additionally, the example environment 130 includes a network-connected speaker 178. The network-connected speaker 178 provides voice assistant services that include providing voice control of network-connected devices. The functions of the hub 176 may be hosted in the network-connected speaker 178. The network-connected speaker 178 can be configured to communicate via the HAN, which may include a wireless mesh network, a Wi-Fi network, or both.

FIG. 2A is a block diagram illustrating a representative network architecture 200 that includes a home area network 202 (HAN 202) in accordance with some implementations. In some implementations, smart devices 204 (e.g., wireless network devices 102) in the network environment 100 combine with the hub 176 to create a mesh network in the HAN 202. In some implementations, one or more of the smart devices 204 in the HAN 202 operate as a smart home controller. Additionally and/or alternatively, the hub 176 may operate as the smart home controller. In some implementations, a smart home controller has more computing power than other smart devices. The smart home controller can process inputs (e.g., from smart devices 204, end-user devices 168, and/or server system 206) and send commands (e.g., to smart devices 204 in the HAN 202) to control operation of the network environment 100. In aspects, some of the smart devices 204 in the HAN 202 (e.g., in the mesh network) are “spokesman” nodes (e.g., 204-1, 204-2) and others are “low-powered” nodes (e.g., 204-n). Some of the smart devices in the network environment 100 may be battery-powered, while others may have a regular and reliable power source, such as via line power (e.g., to 120V line voltage wires). The smart devices that have a regular and reliable power source are referred to as “spokesman” nodes. These nodes are typically equipped with the capability of using a wireless protocol to facilitate bidirectional communication with a variety of other devices in the network environment 100, as well as with the server system 206 (e.g., cloud service 112, partner cloud service 122). In some implementations, one or more “spokesman” nodes operate as a smart home controller. On the other hand, the devices that are battery-powered are the “low-power” nodes. These nodes tend to be smaller than spokesman nodes and typically only communicate using wireless protocols that require very little power, such as Zigbee, ZWave, 6LoWPAN, Thread, Bluetooth, etc.

Some low-power nodes may be incapable of bidirectional communication. These low-power nodes send messages but are unable to “listen”. Thus, other devices in the network environment 100, such as the spokesman nodes, cannot send information to these low-power nodes.

Some low-power nodes may be capable of only a limited bidirectional communication. As a result of such limited bidirectional communication, other devices may be able to communicate with these low-power nodes only during a certain time period.

As described, in some implementations, the smart devices serve as low-power and spokesman nodes to create a mesh network in the network environment 100. In some implementations, individual low-power nodes in the network environment regularly send out messages regarding what they are sensing, and the other low-powered nodes in the network environment—in addition to sending out their own messages—forward the messages, thereby causing the messages to travel from node to node (e.g., device to device) throughout the HAN 202. In some implementations, the spokesman nodes in the HAN 202, which are able to communicate using a relatively high-power communication protocol (e.g., IEEE 802.11), are able to switch to a relatively low-power communication protocol (e.g., IEEE 802.15.4) to receive these messages, translate the messages to other communication protocols, and send the translated messages to other spokesman nodes and/or the server system 206 (using, e.g., the relatively high-power communication protocol). Thus, the low-powered nodes using low-power communication protocols are able to send and/or receive messages across the entire HAN 202, as well as over the Internet (e.g., network 108) to the server system 206. In some implementations, the mesh network enables the server system 206 to regularly receive data from most or all of the smart devices in the home, make inferences based on the data, facilitate state synchronization across devices within and outside of the HAN 202, and send commands to one or more of the smart devices to perform tasks in the network environment.

As described, the spokesman nodes and some of the low-powered nodes are capable of “listening.” Accordingly, users, other devices, and/or the server system 206 may communicate control commands to the low-powered nodes. For example, a user may use the end-user device 168 (e.g., a smart phone) to send commands over the Internet to the server system 206, which then relays the commands to one or more spokesman nodes in the HAN 202. The spokesman nodes may use a low-power protocol to communicate the commands to the low-power nodes throughout the HAN 202, as well as to other spokesman nodes that did not receive the commands directly from the server system 206.

In some implementations, a lighting unit 138 (FIG. 1B), which is an example of a smart device 204, may be a low-power node. In addition to housing a light source, the lighting unit 138 may house an occupancy sensor (e.g., occupancy sensor 150), such as an ultrasonic or passive IR sensor, and an ambient light sensor (e.g., ambient light sensor 170), such as a photo resistor or a single-pixel sensor that measures light in the room. In some implementations, the lighting unit 138 is configured to activate the light source when its ambient light sensor detects that the room is dark and when its occupancy sensor detects that someone is in the room. In other implementations, the lighting unit 138 is simply configured to activate the light source when its ambient light sensor detects that the room is dark. Further, in some implementations, the lighting unit 138 includes a low-power wireless communication chip (e.g., a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly (e.g., using the mesh network) from node to node (e.g., smart device to smart device) within the HAN 202 as well as over the Internet 108 to the server system 206.

Other examples of low-power nodes include battery-operated versions of the hazard detectors 134. These hazard detectors 134 are often located in an area without access to constant and reliable power and may include any number and type of sensors, such as smoke/fire/heat sensors (e.g., thermal radiation sensors), carbon monoxide/dioxide sensors, occupancy/motion sensors, ambient light sensors, ambient temperature sensors, humidity sensors, and the like. Furthermore, hazard detectors 134 may send messages that correspond to each of the respective sensors to the other devices and/or the server system 206, such as by using the mesh network as described above.

Examples of spokesman nodes include entryway interface devices 146 (e.g., smart doorbells), thermostats 132, control panels 166, electrical outlets 154, and other wireless network devices 140. These devices are often located near and connected to a reliable power source, and therefore may include more power-consuming components, such as one or more communication chips capable of bidirectional communication in a variety of protocols.

In some implementations, the network environment 100 includes controlled systems 156, such as service robots, that are configured to carry out, in an autonomous manner, any of a variety of household tasks.

As explained with reference to FIG. 1B, in some implementations, the network environment 100 includes a hub device (e.g., hub 176) that is communicatively coupled to the network(s) 108 directly or via a network interface 208 (e.g., access point 110). The hub 176 is further communicatively coupled to one or more of the smart devices 204 using a radio communication network that is available at least in the network environment 100. Communication protocols used by the radio communication network include, but are not limited to, ZigBee, Z-Wave, Insteon, EuOcean, Thread, OSIAN, Bluetooth Low Energy and the like. In some implementations, the hub 176 not only converts the data received from each smart device to meet the data format requirements of the network interface 208 or the network(s) 108, but also converts information received from the network interface 208 or the network(s) 108 to meet the data format requirements of the respective communication protocol associated with a targeted smart device. In some implementations, in addition to data format conversion, the hub 176 further processes the data received from the smart devices or information received from the network interface 208 or the network(s) 108 preliminary. For example, the hub 176 can integrate inputs from multiple sensors/connected devices (including sensors/devices of the same and/or different types), perform higher level processing on those inputs—e.g., to assess the overall environment and coordinate operation among the different sensors/devices—and/or provide instructions to the different devices based on the collection of inputs and programmed processing. It is also noted that in some implementations, the network interface 208 and the hub 176 are integrated to one network device. Functionality described herein is representative of particular implementations of smart devices, control application(s) running on representative electronic device(s) (such as a smart phone), hub(s) 176, and server system(s) 206 coupled to hub(s) 176 via the Internet or other Wide Area Network. All or a portion of this functionality and associated operations can be performed by any elements of the described system—for example, all or a portion of the functionality described herein as being performed by an implementation of the hub can be performed, in different system implementations, in whole or in part on the server, one or more connected smart devices and/or the control application, or different combinations thereof.

FIG. 2B illustrates a representative operating environment 220 in which a server system 206 provides data processing for monitoring and facilitating review of events (e.g., motion, audio, security, etc.) in video streams captured by cameras 136 (e.g., video cameras, doorbell cameras). As shown in FIG. 2B, the server system 206 receives video data from video sources 222 (including video cameras 224 or video-recording doorbell devices 226) located at various physical locations (e.g., inside or in proximity to homes, restaurants, stores, streets, parking lots, and/or the network environments 100 of FIG. 1). Each video source 222 may be linked to one or more reviewer accounts, and the server system 206 provides video monitoring data for the video source 222 to client devices 228 associated with the reviewer accounts. For example, the portable end-user device 168 is an example of the client device 228. In some implementations, the server system 206 is a video processing server that provides video processing services to the video sources and client devices 228.

In some implementations, the server system 206 receives non-video data from one or more smart devices 204 (e.g., audio data, metadata, numerical data, etc.). The non-video data may be analyzed to provide context for motion events detected by the video cameras 224 and/or the video-recording doorbell devices 226. In some implementations, the non-video data indicates that an audio event (e.g., detected by an audio device such as an audio sensor integrated in the network-connected speaker 178), a security event (e.g., detected by a perimeter monitoring device such as the camera 136 and/or a motion sensor), a hazard event (e.g., detected by the hazard detector 134), medical event (e.g., detected by a health-monitoring device), or the like has occurred within a network environment 100.

In some implementations, multiple reviewer accounts are linked to a single network environment 100. For example, multiple occupants of a network environment 100 may have accounts linked to the network environment 100. In some implementations, each reviewer account is associated with a particular level of access. In some implementations, each reviewer account has personalized notification settings. In some implementations, a single reviewer account is linked to multiple network environments 100 (e.g., multiple different HANs). For example, a person may own or occupy, or be assigned to review and/or govern, multiple network environments 100. In some implementations, the reviewer account has distinct levels of access and/or notification settings for each network environment.

In some implementations, each of the video sources 222 includes one or more video cameras 224 or video-recording doorbell devices 226 that capture video and send the captured video to the server system 206 substantially in real-time. In some implementations, each of the video sources 222 includes one or more doorbell devices 226 that capture video and send the captured video to the server system 206 in real-time (e.g., within 1 second, 10 seconds, 30 seconds, or 1 minute). Each of the doorbell devices 226 may include a video camera that captures video and sends the captured video to the server system 206 in real-time. In aspects, a video source 222 includes a controller device (not shown) that serves as an intermediary between the one or more doorbell devices 226 and the server system 206. The controller device receives the video data from the one or more doorbell devices 226, optionally performs some preliminary processing on the video data, and sends the video data and/or the results of the preliminary processing to the server system 206 on behalf of the one or more doorbell devices 226 (e.g., in real-time). In some implementations, each camera has its own on-board processing capabilities to perform some preliminary processing on the captured video data before sending the video data (e.g., along with metadata obtained through the preliminary processing) to the controller device and/or the server system 206. In some implementations, one or more of the cameras is configured to, optionally, locally store the video data (e.g., for later transmission if requested by a user). In some implementations, a camera is configured to perform some processing of the captured video data and based on the processing, either send the video data in substantially real-time, store the video data locally, or disregard the video data.

In accordance with some implementations, a client device 228 includes a client-side module 230. In some implementations, the client-side module communicates with a server-side module 232 executed on the server system 206 through the one or more networks 108. The client-side module provides client-side functionality for the event monitoring and review processing and communications with the server-side module. The server-side module provides server-side functionality for event monitoring and review processing for any number of client-side modules each residing on a respective client device 228 (e.g., any one of client devices 228-1 to 228-m). In some implementations, the server-side module 232 also provides server-side functionality for video processing and camera control for any number of the video sources 222, including any number of control devices, cameras 136, and doorbell devices 226.

In some implementations, the server system 206 includes one or more processors 234, a video storage database 236, an account database 238, an input/output (I/O) interface 240 to one or more client devices 228, and an I/O interface 242 to one or more video sources 222. The I/O interface 242 to one or more client devices 228 facilitates the client-facing input and output processing. The account database 238 stores a plurality of profiles for reviewer accounts registered with the video processing server, where a respective user profile includes account credentials for a respective reviewer account, and one or more video sources linked to the respective reviewer account. The I/O interface 242 to one or more video sources 222 facilitates communications with one or more video sources 222 (e.g., groups of one or more doorbell devices 226, cameras 136, and associated controller devices). The video storage database 236 stores raw video data received from the video sources 222, as well as various types of metadata, such as motion events, event categories, event categorization models, event filters, and event masks, for use in data processing for event monitoring and review for each reviewer account.

Examples of a representative client device 228 include a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, a point-of-sale (POS) terminal, a vehicle-mounted computer, an ebook reader, or a combination of any two or more of these data processing devices or other data processing devices.

Examples of the one or more networks 108 include local area networks (LAN) and wide area networks (WAN) such as the Internet. The one or more networks 108 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VOIP), Wi-MAX, or any other suitable communication protocol.

In some implementations, the server system 206 is implemented on one or more standalone data processing apparatuses or a distributed network of computers. The server system 206 may also employ various virtual devices and/or services of third-party service providers (e.g., third-party cloud service providers) to provide the underlying computing resources and/or infrastructure resources of the server system 206. In some implementations, the server system 206 includes, but is not limited to, a server computer, a handheld computer, a tablet computer, a laptop computer, a desktop computer, or a combination of any two or more of these data processing devices or other data processing devices.

The server-client environment shown in FIG. 2B includes both a client-side portion (e.g., the client-side module) and a server-side portion (e.g., the server-side module). The division of functionality between the client and server portions of an operating environment can vary in different implementations. Similarly, the division of functionality between a video source 222 and the server system 206 can vary in different implementations. For example, in some implementations, the client-side module is a thin-client that provides only user-facing input and output processing functions, and delegates all other data processing functionality to a backend server (e.g., the server system 206). Similarly, in some implementations, a respective one of the video sources 222 is a simple video capturing device that continuously captures and streams video data to the server system 206 with limited or no local preliminary processing on the video data. Although many aspects of the present technology are described from the perspective of the server system 206, the corresponding actions performed by a client device 228 and/or the video sources 222 would be apparent to one of skill in the art. Similarly, some aspects of the present technology may be described from the perspective of a client device or a video source, and the corresponding actions performed by the video server would be apparent to one of skill in the art. Furthermore, some aspects of the present technology may be performed by the server system 206, a client device 228, and a video source 222 cooperatively.

In some aspects, a video source 222 (e.g., a video camera 224 or a doorbell device 226 having an image sensor) transmits one or more streams 244 of video data to the server system 206. In some implementations, the one or more streams include multiple streams, having respective resolutions and/or frame rates, of the raw video captured by the image sensor. In some implementations, the multiple streams include a “primary” stream (e.g., 244-1) with a certain resolution and frame rate, corresponding to the raw video captured by the image sensor, and one or more additional streams (e.g., 244-2 through 244-q). An additional stream is optionally the same video stream as the “primary” stream but at a different resolution and/or frame rate, or a stream that captures a portion of the “primary” stream (e.g., cropped to include a portion of the field of view or pixels of the primary stream) at the same or different resolution and/or frame rate as the “primary” stream. In some implementations, the primary stream and/or the additional streams are dynamically encoded (e.g., based on network conditions, server operating conditions, camera operating conditions, characterization of data in the stream (e.g., whether motion is present), user preferences, and the like.

In some implementations, one or more of the streams 244 is sent from the video source 222 directly to a client device 228 (e.g., without being routed to, or processed by, the server system 206). In some implementations, one or more of the streams is stored at a local memory of the doorbell device 226 and/or at a local storage device (e.g., a dedicated recording device), such as a digital video recorder (DVR). For example, in accordance with some implementations, the doorbell device 226 stores the most-recent 24 hours of video footage recorded by the camera. In some implementations, portions of the one or more streams are stored at the doorbell device 226 and/or the local storage device (e.g., portions corresponding to particular events or times of interest).

In some implementations, the server system 206 transmits one or more streams 246 of video data to a client device 228 to facilitate event monitoring by a user. In some implementations, the one or more streams may include multiple streams, of respective resolutions and/or frame rates, of the same video feed. In some implementations, the multiple streams include a “primary” stream (e.g., 246-1) with a certain resolution and frame rate, corresponding to the video feed, and one or more additional streams (e.g., 246-2 through 246-t). An additional stream may be the same video stream as the “primary” stream but at a different resolution and/or frame rate, or a stream that shows a portion of the “primary” stream (e.g., cropped to include portion of the field of view or pixels of the primary stream) at the same or different resolution and/or frame rate as the “primary” stream.

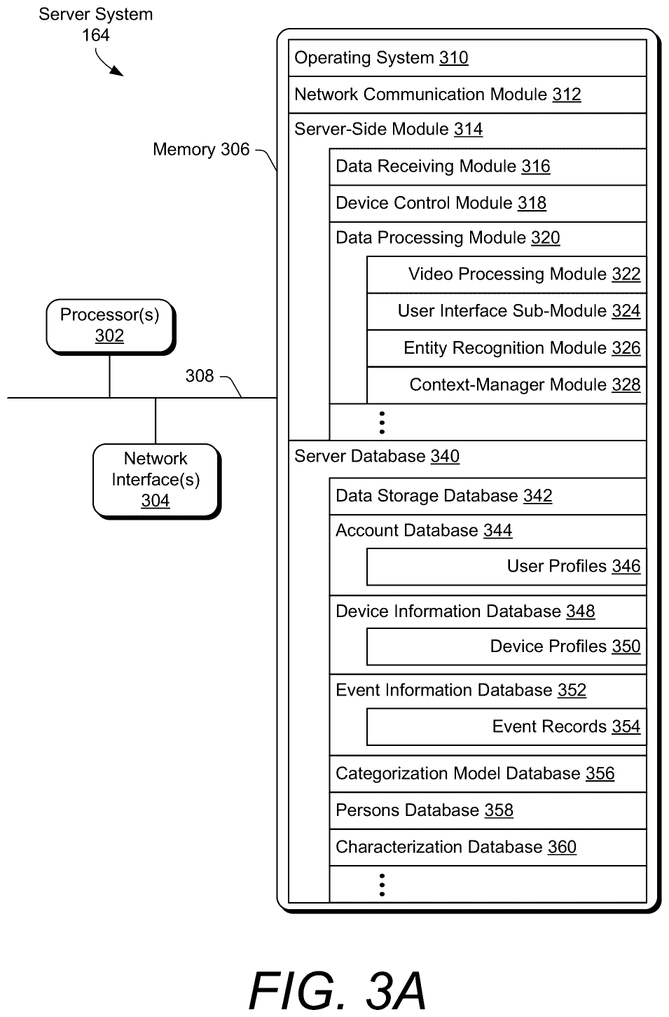

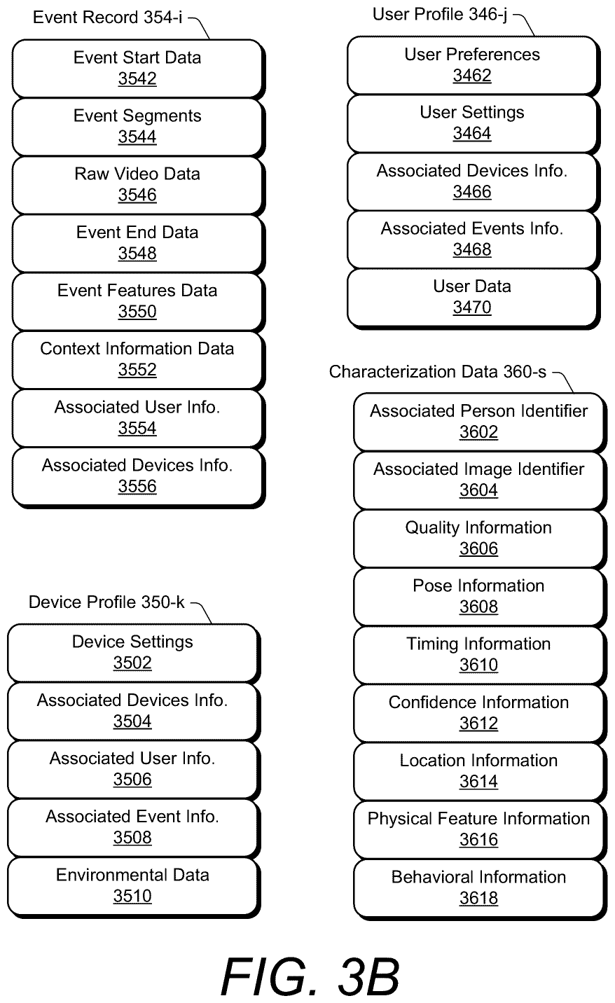

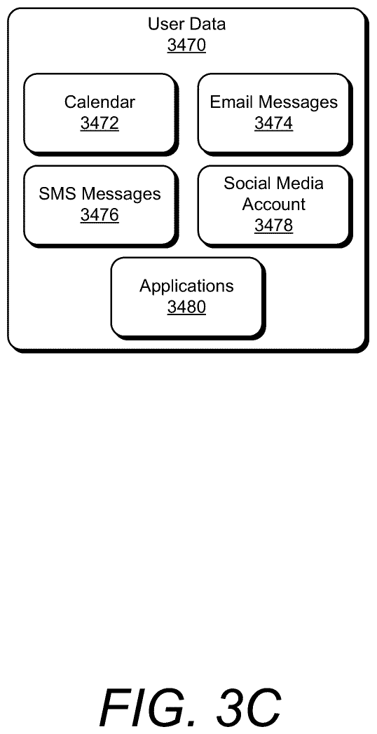

FIG. 3A is a block diagram illustrating the server system 206 in accordance with some implementations. The server system 206 typically includes one or more processors 302, one or more network interfaces 304 (e.g., including the I/O interface 240 to one or more client devices and the I/O interface 242 to one or more electronic devices), memory 306, and one or more communication buses 308 for interconnecting these components (sometimes called a chipset). The memory 306 includes high-speed random access memory, such as DRAM, SRAM, DDR SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 306, optionally, includes one or more storage devices remotely located from one or more of the processors 302. The memory 306, or alternatively the non-volatile memory within memory 306, includes a non-transitory computer readable storage medium. In some implementations, the memory 306, or the non-transitory computer readable storage medium of the memory 306, stores the following programs, modules, and data structures, or a subset or superset thereof:
an operating system 310 including procedures for handling various basic system services and for performing hardware dependent tasks;
a network communication module 312 for connecting the server system 206 to other systems and devices (e.g., client devices, electronic devices, and systems connected to one or more networks 108) via one or more network interfaces 304 (wired or wireless);
a server-side module 314 (e.g., server-side module 232), which provides server-side functionalities for device control, data processing, and data review, including, but not limited to:
   a data receiving module 316 for receiving data from electronic devices (e.g., video data from a doorbell device 226, FIG. 1), and preparing the received data for further processing and storage in a data storage database (e.g., data storage database 342);
   a device control module 318 for generating and sending server-initiated control commands to modify operation modes of electronic devices (e.g., devices of a network environment 100), and/or receiving (e.g., from client devices 228) and forwarding user-initiated control commands to modify operation modes of the electronic devices;
   a data processing module 320 for processing the data provided by the electronic devices, and/or preparing and sending processed data to a device for review (e.g., client devices 228 for review by a user), including, but not limited to:
      a video processor sub-module 322 for processing (e.g., categorizing and/or recognizing) detected entities and/or event candidates within a received video stream (e.g., a video stream from doorbell device 226);
      a user interface sub-module 324 for communicating with a user (e.g., sending alerts, timeline events, etc. and receiving user edits and zone definitions and the like); and
      an entity recognition module 326 for analyzing and/or identifying persons detected within network environments;
      a context-manager module 328 for determining contexts, or estimating possible contexts, of persons detected within network environments and context-based options associated with determined or estimated contexts; and
a server database 340, including but not limited to:
   a data storage database 342 for storing data associated with each electronic device (e.g., each doorbell) of each user account, as well as data processing models, processed data results, and other relevant metadata (e.g., names of data results, location of electronic device, creation time, duration, settings of the electronic device, etc.) associated with the data, where (optionally) all or a portion of the data and/or processing associated with the hub 176 or smart devices are stored securely;
   an account database 344 for storing account information for user accounts, including user account information such as user profiles 346, information and settings for linked hub devices and electronic devices (e.g., hub device identifications), hub device specific secrets, relevant user and hardware characteristics (e.g., service tier, device model, storage capacity, processing capabilities, etc.), user interface settings, data review preferences, etc., where the information for associated electronic devices includes, but is not limited to, one or more device identifiers (e.g., a media access control (MAC) address and universally unique identifier (UUID)), device specific secrets, and displayed titles;
   a device information database 348 for storing device information related to one or more devices such as device profiles 350, e.g., device identifiers and bub device specific secrets, independently of whether the corresponding hub devices have been associated with any user account;
   an event information database 352 for storing event information such as event records 354 and context information, e.g., context-based data describing circumstances surrounding an approaching guest;
   a categorization model database 356 for storing event categorization models related to event categories for categorizing events detected by, or involving, the smart device;
   a persons database 358 for storing information regarding detected and/or recognized persons, such as images (e.g., cropped headshots) of detected persons and feature characterization data for the persons; and
   a characterization database 360 for use with characterizing motion, persons, and events within the network environment, e.g., in conjunction with the data processing module 320.

Each of the above identified elements may be stored in one or more of the previously mentioned memory devices and may correspond to a set of instructions for performing a function described above. The above identified modules or programs (e.g., sets of instructions) need not be implemented as separate software programs, procedures, or modules, and thus various subsets of these modules may be combined or otherwise rearranged in various implementations. In some implementations, the memory 306, optionally, stores a subset of the modules and data structures identified above. Furthermore, the memory 306, optionally, stores additional modules and data structures not described above.

FIG. 3B illustrates various data structures used by some implementations, including an event record 354-i, a user profile 346-j, a device profile 350-k, and characterization data 360-s. The event record 354-i corresponds to an event T and data for the event T. In some implementations, the event T includes one or more of: a motion event, a hazard event, a medical event, a power event, an audio event, and a security event. In some instances, the data for a motion event T includes event start data 3542 indicating when and/or how the event started, event segments data 3544, raw video data 3546, event end data 3548 indicating when and/or how the event ended, event features data 3550, context information data 3552, associated user information 3554 (e.g., user participating in the event and/or users associated with the network environment in which the event took place), and associated devices information 3556. In some instances, the event record 354-i includes only a subset of the above data. In some instances, the event record 354-i includes additional event data not shown such as data regarding event/motion masks.

The event start data 3542 includes date and time information such as a timestamp and optionally includes additional information such as information regarding the amount of motion present, a motion start location, amount of audio present, characteristics of the audio, and the like. Similarly, the event end data 3548 includes date and time information such as a timestamp and optionally includes additional information such as information regarding the amount of motion present, a motion start location, amount of audio present, characteristics of the audio, and the like.

The event segments data 3544 includes information regarding segmentation of the motion event T. In some instances, event segments are stored separately from the video data 3546. In some instances, the event segments are stored at a different (lower) display resolution than the video data. For example, the event segments are optionally stored at 480p or 780p and the video data is stored at 1080i or 1080p. Storing the event segments at a lower display resolution enables the system to devote less time and resources to retrieving and processing the event segments. In some instances, the event segments are not stored separately and the segmentation information includes references to the video data 3546 as well as date and time information for reproducing the event segments. In some implementations, the event segments include one or more audio segments (e.g., corresponding to video segments).

The event features data 3550 includes information regarding event features such as event categorizations/classifications, object masks, motion masks, identified/recognized/tracked motion objects (also sometimes called blobs), information regarding features of the motion objects (e.g., object color, object dimensions, velocity, size changes, etc.), information regarding activity in zones of interest, and the like.

The context information data 3552 includes context information regarding the event such as information regarding the guest (e.g., behavior, clothing, or size characteristics), information regarding approach timing (e.g., time of day, level of brightness), information regarding guest announcements (e.g., doorbell press, knocking, and associated timing thereof), information regarding scheduling (e.g., proximity in time to a prescheduled event, or proximity in time to a prescheduled status of the network environment), information regarding the status or location of one or more users, and the like.

The associated user information 3554 includes information regarding users associated with the event such as users identified in the event, users receiving notification of the event, and the like. In some instances, the associated user information 3554 includes a link, pointer, or reference to a user profile 346 for to the user. The associated devices information 3556 includes information regarding the device or devices involved in the event (e.g., a doorbell device 226 that recorded the event). In some instances, the associated devices information 3556 includes a link, pointer, or reference to a device profile 350 for the device.

The user profile 346-j corresponds to a user ‘j’ associated with the network environment 100 (e.g., HAN 202) such as a user of a smart device 204, a user identified by a smart device 204, a user who receives notifications from a smart device 204 or from the server system 206, and the like. In some instances, the user profile 346-j includes user preferences 3462, user settings 3464, associated devices information 3466, associated events information 3468, and user data 3470. In some instances, the user profile 346-j includes only a subset of the above data. In some instances, the user profile 346-j includes additional user information not shown, such as information regarding other users associated with the user ‘j’ and/or information regarding network environments linked to the user.

The user preferences 3462 include explicit user preferences input by the user as well as implicit and/or inferred user preferences determined by the system (e.g., server system 206 and/or client device 228). In some instances, the inferred user preferences are based on historical user activity and/or historical activity of other users. The user settings 3464 include information regarding settings set by the user ‘j’ such as notification settings, device settings, and the like. In some instances, the user settings 3464 include device settings for devices associated with the user ‘j’.

The associated devices information 3466 includes information regarding devices associated with the user ‘j’ such as devices within the user's network environment(s) 100 and/or client device(s) 228. In some instances, associated devices information 3466 includes a link, pointer, or reference to a corresponding device profile 350. Associated events information 3468 includes information regarding events associated with user ‘j’ such as events in which user ‘j’ was identified, events for which user ‘j’ was notified, events corresponding to a network environment 100 of user ‘j,’ and the like. In some instances, the associated events information 3468 includes a link, pointer, or reference to a corresponding event record 354.

The user data 3470 is described in more detail in FIG. 3C, which illustrates an example implementation of information that is associated with a user and is usable to provide context-based options to a guest via a wireless network device 102. The user data 3470 includes information usable to help determine the context-based options to provide via a user interface of the wireless network device 102 when a guest's presence is detected. Further, the user data 3470 may be associated with various sources of information corresponding to the user profile 346 of the user (e.g., occupant) and usable to determine possible contexts of the guest, such as a particular guest whose presence is anticipated within a particular block of time. For example, the user data 3470 may include, or be associated with, a digital calendar 3472, email messages 3474, short message service (SMS) messages 3476, a social media account 3478, and one or more applications 3480 (“apps”).

The calendar 3472 of the user may be accessible via the network 108 and may include the user's schedule (e.g., appointments, meetings, notifications, announcements, reminders). In aspects, the user's schedule may include information usable to predict a potential guest or guest type along with estimated reasons for their visit. For example, if the calendar 3472 indicates that the user is expecting a visit from an appliance repairman between 12:00 PM and 2:00 PM, then when a guest arrives during that period of time, the wireless network device 102 may provide one or more context-based options corresponding to the expected appliance repairman.

Messages, notifications, or other communications sent or received via the user's email messages 3474, SMS messages 3476, social media account 3478, and/or applications 3480 associated with the user data 3470 may be analyzed to detect whether the user is expecting a visit from a particular guest or type of guest. For example, if the user purchases an e-commerce item and receives an email message indicating an expected delivery time block, the context-manager module 328 can use such information to estimate the context of a guest arriving during the expected delivery time block and provide one or more corresponding context-based options for the guest to select to confirm the intent of their visit. In another example, the user may receive an SMS message 3476 from a friend indicating that they will arrive in one hour. If a guest arrives in one hour and the wireless network device 102 is unable to identify the guest, the wireless network device 102 may populate the user interface with a context-based option associated with the acquaintance along with one or more other possible context-based options based on one or more determined characteristics of the guest.

Similarly, the user may communicate with another person via a social media account 3478 (e.g., for a private sale). Then, when a vehicle arrives that is not recognized and the guest approaching the user's home is not identified, the wireless network device 102 may estimate a possible context for the guest as being a person interested in the private sale discussed over the social media account 3478. Further, the wireless network device 102 may provide a corresponding context-based option via the user interface for the guest to select to confirm that their intent for the visit is to participate in the private sale (e.g., purchase an item from the user or sell an item to the user). Any suitable application 3600 interacted with by the user (e.g., via the user's smartphone or other electronic device) may include information usable to predict a potential context for the guest at any given time.

Returning to FIG. 3B, the device profile 350-k corresponds to a device ‘k’ associated with a network environment 100 (e.g., HAN 202) such as a camera 136, a doorbell device 226, a client device 228, and the like. In some instances, the device profile 350-k includes device settings 3502, associated devices information 3504, associated user information 3506, associated event information 3508, and environmental data 3510. In some instances, the device profile 350-k includes only a subset of the above data. In some instances, the device profile 350-k includes additional device information not shown such as information regarding a current state of the device ‘k’.

The device settings 3502 include information regarding the current settings of device ‘k’ such as positioning information, mode of operation information, and the like. In some implementations and instances, the device settings 3502 are user-specific and are set by respective users of the device ‘k’. The associated devices information 3504 includes information regarding other devices associated with device ‘k’ such as other devices linked to device ‘k’ and/or other devices in the same network environment as device ‘k’. In some instances, the associated devices information 3504 includes a link, pointer, or reference to a respective device profile 350 of the associated device.

The associated user information 3506 includes information regarding users (also referred to herein as occupants of the structure 104) associated with the device such as users receiving notifications from the device, users registered with the device, users associated with the network environment of the device, and the like. In some instances, the associated user information 3506 includes a link, pointer, or reference to a user profile 346 corresponding to the associated user.

The associated event information 3508 includes information regarding events associated with the device ‘k’ such as historical events involving the device ‘k’ or captured by the device ‘k’. In some instances, the associated event information 3508 includes a link, pointer, or reference to an event record 354 corresponding to the associated event.

The environmental data 3510 includes information regarding the environment of device ‘k’ such as information regarding whether the device is outdoors or indoors, information regarding the light level of the environment, information regarding the amount of activity expected in the environment (e.g., information regarding whether the device is in a private residence versus a busy commercial property), information regarding environmental objects (e.g., depth mapping information for a camera), and the like.

The characterization data 360-s corresponds to an event ‘s’ detected within the network environment 100. As shown in FIG. 3B, in accordance with some implementations, the characterization data 360 includes an associated person identifier 3602, an associated image identifier 3604, quality information 3606, pose information 3608, timing information 3610, confidence information 3612, location information 3614, physical feature information 3616, and behavioral information 3618. In some implementations, the characterization data 360 includes additional data not shown, such as the smart devices or sensors that detected the event. In some implementations, the characterization data 360 includes only a subset of the data shown.

The associated person identifier 3602 includes a label or other identifier for each person represented by the characterization data. In some implementations, a label is applied by a user upon review of the corresponding image. In some implementations, the associated person identifier 3602 is assigned by the system in accordance with a determination that the characterization data 360 matches, or is similar to, other characterization data associated with the identifier.

The associated image identifier 3604 identifies one or more images from which the characterization data 360 was generated. In some implementations, there is a one-to-one mapping between the characterization data and the images, while in some other implementations, there is a many-to-one or one-to-many mapping. In some implementations, the associated image identifier 3604 includes a pointer or logical storage address for the one or more images.

The quality information 3606 includes a quality factor for the characterization data 360. In some implementations, the quality factor is based on one or more of: a blurriness of the image, a resolution of the image, an amount of the person that is visible in the image, how many features of the person are visible in the image, and a distance between the person and the camera that captured the image.

The pose information 3608 identifies a pose of each detected person. In some implementations, the pose information 3608 includes information regarding an angle between the camera that captured the image and the detected person. In some implementations, the pose information 3608 includes information regarding a portion of the person's face that is visible in the image.

The timing information 3610 includes information regarding when the image was captured by the camera. In some implementations, the timing information 3610 indicates the time of day, the day, the month, the year, etc. that the image was captured. In some implementations, the characterization data 360 includes operating information for the camera indicating the mode of operation and settings of the camera (e.g., indicating whether the camera was in a low-light mode when the image was captured). In some implementations, the timing information 3610 is used in conjunction with a device profile 350 for the camera to determine operating information for the camera at the time the image was captured.

The confidence information 3612 indicates a confidence that the associated person identifier(s) 3602 are accurate. In some implementations, the confidence information 3612 is based on a similarity between the characterization data 360 and other characterization data for the associated person(s). In some implementations, the confidence information 3612 includes a confidence score for the characterization data 360. In some implementations, in accordance with a determination that the confidence score is below a predetermined threshold, the association to the person(s) is reevaluated and/or the characterization data 360 and associated image is flagged as potentially having an incorrect associated person identifier 3602. In some implementations, flagged characterization data 360 is presented to a user for confirmation or reclassification.

The location information 3614 includes information regarding a location for the image and/or the detected person. In some implementations, the location information 3614 indicates a location for the camera that captured the image. In some implementations, the location information 3614 identifies the camera that captured the image. In some implementations, the location information 3614 indicates a room or portion of the network environment that was captured in the image. In some implementations, the location information 3614 indicates a global navigation satellite system (GNSS) (e.g., global positioning system (GPS)) or coordinates-based location for the image.

The physical feature information 3616 includes information regarding the physical features of the detected person(s). In some implementations, the physical feature information 3616 includes characterization of the person's physical features (e.g., nose, ears, eyes, and hair). In some implementations, the physical feature information 3616 includes information regarding the person's speech, gait, and/or posture. In some implementations, the physical feature information 3616 includes information regarding the person's dimensions, such as the distance between the person's eyes or ears, or the length of the person's arms or legs. In some implementations, the physical feature information 3616 includes information regarding of the person's age, gender, and/or ethnicity. In some implementations, the physical feature information 3616 includes information regarding the person's clothing and/or accessories (e.g., whether the person is wearing a hat, glasses, gloves, and/or rings).

The behavioral information 3618 includes information regarding the behavior of the detected person. In some implementations, the behavioral information 3618 includes information regarding the detected person's mood and/or mannerisms.

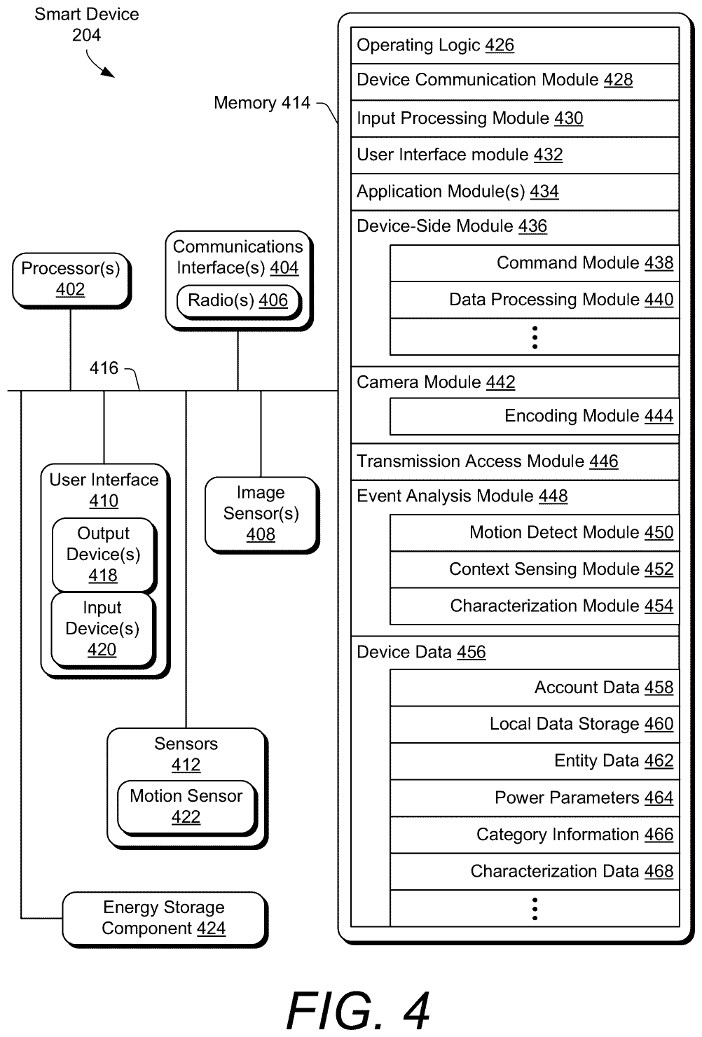

FIG. 4 is a block diagram illustrating a representative smart device 204 in accordance with some implementations. In some implementations, the smart device 204 (e.g., any device of the network environment 100 in FIG. 1) includes one or more processors 402 (e.g., CPUs, ASICS, FPGAs, microprocessors, and the like), one or more communication interfaces 404 with radios 406, image sensor(s) 408, user interface(s) 410, sensor(s) 412, memory 414, and one or more communication buses 416 for interconnecting these components (sometimes called a chipset). In some implementations, the user interface 410 includes one or more output devices 418 that enable presentation of media content, including one or more speakers and/or one or more visual displays. In some implementations, the user interface 410 includes one or more input devices 420, including user interface components that facilitate user input such as a keyboard, a mouse, a voice-command input unit or microphone, a touch screen display, a touch-sensitive input pad, a gesture capturing camera, or other input buttons or controls. In some implementations, an input device 420 for a doorbell device 226 is a tactile or touch-sensitive doorbell button. Furthermore, some smart devices 204 use a microphone and voice recognition or a camera and gesture recognition to supplement or replace the keyboard.

The sensor(s) 422 include, for example, one or more thermal radiation sensors, ambient temperature sensors, humidity sensors, infrared (IR) sensors such as passive infrared (PIR) sensors, proximity sensors, range sensors, occupancy sensors (e.g., using radio frequency identification (RFID) sensors), ambient light sensors (ALS), motion sensors 422, location sensors (e.g., GPS sensors), accelerometers, and/or gyroscopes.

In some implementations, the smart device 204 includes an energy storage component 424 (e.g., one or more batteries and/or capacitors). In some implementations, the energy storage component 424 includes a power management integrated circuit (IC). In some implementations, the energy storage component 424 includes circuitry to harvest energy from signals received via an antenna (e.g., the radios 406) of the smart device. In some implementations, the energy storage component 424 includes circuitry to harvest thermal, vibrational, electromagnetic, and/or solar energy received by the smart device. In some implementations, the energy storage component 424 includes circuitry to monitor a stored energy level and adjust operation and/or generate notifications based on changes to the stored energy level.

The communication interfaces 404 include, for example, hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, etc.) and/or any of a variety of custom or standard wired protocols (e.g., Ethernet, HomePlug, etc.), or any other suitable communication protocol, including communication protocols not yet developed as of the filing date of this document. The radios 406 enable one or more radio communication networks in the network environments 100 and enable a smart device 204 to communicate with other devices. In some implementations, the radios 406 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, etc.).

The memory 426 includes high-speed random access memory (e.g., DRAM, SRAM, DDR RAM, or other random access solid state memory devices) and, optionally, includes non-volatile memory (e.g., one or more magnetic disk storage devices, one or more optical disk storage devices, one or more flash memory devices, or one or more other non-volatile solid state storage devices). The memory 426, or alternatively the non-volatile memory within the memory 426, includes a non-transitory computer readable storage medium. In some implementations, the memory 426, or the non-transitory computer readable storage medium of the memory 426, stores the following programs, modules, and data structures, or a subset or superset thereof:
operating logic 426 including procedures for handling various basic system services and for performing hardware dependent tasks;
a communication module 428 for coupling to and communicating with other network devices (e.g., a network interface 208, such as a router that provides Internet connectivity, networked storage devices, network routing devices, a server system 206, other smart devices 204, client devices 228, etc.) connected to one or more networks 108 via one or more communication interfaces 404 (wired or wireless);
an input processing module 430 for detecting one or more user inputs or interactions from the one or more input devices 420 and interpreting the detected inputs or interactions;
a user interface module 432 for providing and presenting a user interface in which settings, captured data, and/or other data for one or more devices (e.g., the smart device 204, and/or other devices in a network environment 100) can be configured and/or viewed;
one or more applications 434 for execution by the smart device (e.g., games, social network applications, smart home applications, and/or other web or non-web based applications) for controlling devices (e.g., executing commands, sending commands, and/or configuring settings of the smart device 204 and/or other client/electronic devices), and for reviewing data captured by devices (e.g., device status and settings, captured data, or other information regarding the smart device 204 and/or other client/electronic devices);
a device-side module 436, which provides device-side functionalities for device control, data processing and data review, including but not limited to:
   a command module 438 for receiving, forwarding, and/or executing instructions and control commands (e.g., from a client device 228, from a server system 206, from user inputs detected on the user interface 410, etc.) for operating the smart device 204; and
   a data processing module 440 for processing data captured or received by one or more inputs (e.g., input devices 420, image sensor(s) 408, sensors 412, interfaces (e.g, communication interfaces 404, radios 406), and/or other components of the smart device 204, and for preparing and sending processed data to a remote device (e.g., client devices 228) for review by a user;
a camera module 442 for operating the image sensor(s) 408 and associated circuitry, e.g., for enabling and disabling the image sensor(s) 408 based on data from one or more low-power sensors 412 (e.g., data from a PIR sensor or ALS), including an encoding module 444 for adjusting encoding of raw image data captured by the image sensor(s) 408 (e.g., adjusting format, resolution, and/or framerate);
a transmission access module 446 for granting or denying transmission access to one or more radio(s) 406 (e.g., based on detected control signals and transmission requests);
an event analysis module 448 for analyzing captured sensor data, e.g., to detect and/or recognize approaching visitors and context information, including but not limited to:
   a motion detect module 450 for detecting events in the network environment (e.g., motion events in the video data), such as an approaching guest; and
   a context sensing module 452 for detecting context data regarding an approaching guest, e.g., based on behavioral characteristics, object recognition, facial recognition, voice recognition, timing information, and user data associated with a user profile of the user (e.g., occupant);
   a characterization module 454 for characterizing entities, persons (e.g., the approaching guest), and/or events detected by, or associated with, the smart device 204;
device data 456 storing data associated with devices (e.g., the smart device 204), including, but not limited to:
   account data 458 storing information related to user accounts linked to the smart device 204, e.g., including cached login credentials, smart device identifiers (e.g., MAC addresses and UUIDs), user interface settings, display preferences, authentication tokens and tags, password keys, and the like;
   local data storage 460 for selectively storing raw or processed data associated with the smart device 204, such as event data and/or video data captured by the image sensor(s) 408;
   entity data 462 storing information related to detected persons and other entities, such as characterization information (e.g., characterization data 468) and associated images;
   power parameters 464 storing energy information, such as information related to the energy storage component 424 (e.g., estimated battery life), power settings of the smart device 204, a power state of the smart device 204, power preferences of user(s) of the smart device 204, and the like;
   category information 466 detailing event categories for categorizing events detected by, or involving, the smart device (e.g., in conjunction with the event analysis module 448); and
   characterization data 468 for entities, persons, and/or events detected by, or associated with, the smart device 204 (e.g., data generated or used by the characterization module 454).

Each of the above identified elements may be stored in one or more of the previously mentioned memory devices and corresponds to a set of instructions for performing a function described above. The above identified modules or programs (e.g., sets of instructions) need not be implemented as separate software programs, procedures, or modules, and thus various subsets of these modules may be combined or otherwise rearranged in various implementations. In some implementations, the memory 414, optionally, stores a subset of the modules and data structures identified above. Furthermore, the memory 414, optionally, stores additional modules and data structures not described above, such as a sensor management module for managing operation of the sensor(s) 412.

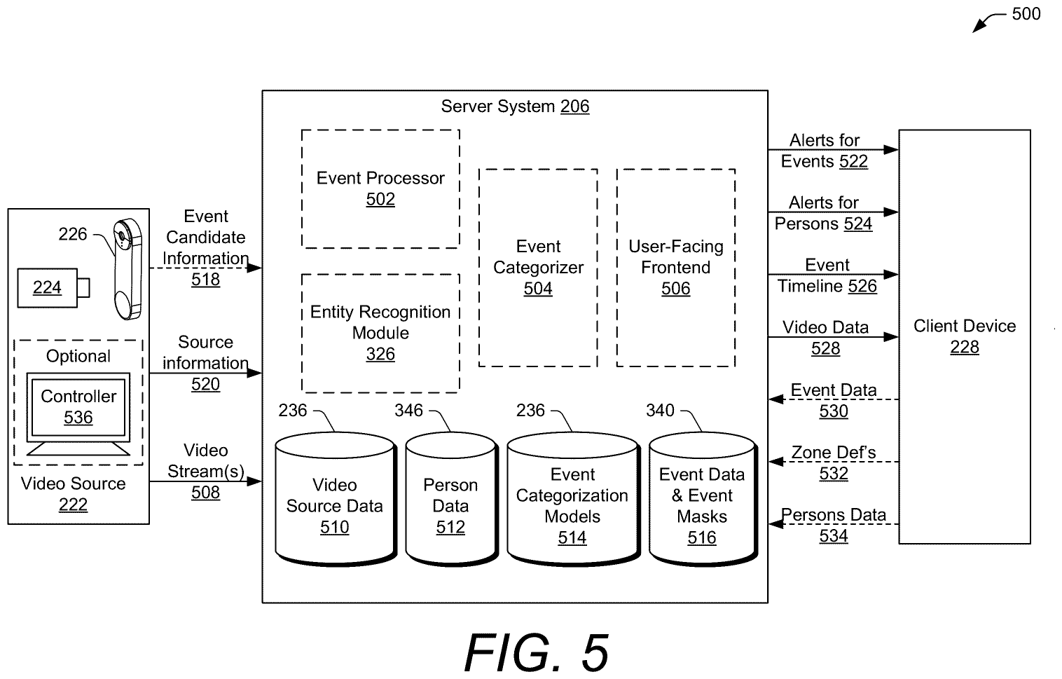

FIG. 5 illustrates a representative system architecture 500 including video source(s) 222, server system 206, and client device(s) 228 in accordance with some implementations. In some implementations, the server system 206 includes functional modules for an event processor 502, an event categorizer 504, an entity recognition module 326, and a user-facing frontend 506 (e.g., server-side module 314). The event processor 502 obtains the event candidates (e.g., by processing video stream(s) 508, by receiving event start information from the video source 222, or by detecting a user press on a doorbell button of a video-recording doorbell device 226). In some implementations, the event candidates comprise motion event candidates. In some implementations, the event candidates comprise audio event candidates. In some implementations, the event candidates include a user press on the doorbell button of the video-recording doorbell device 226. In some implementations, the event candidates include audio, electromagnetic, olfactory, and/or visual aspects. In some implementations, the event candidates include motion events, approach detections, and announcement detections. The event categorizer 504 categorizes the event candidates into different event categories (e.g., based on data from the event processor and/or the entity recognizer). The user-facing frontend 506 generates event alerts and notifications and facilitates review of the detected entities and events by a reviewer through a review interface on a client device 228. The user-facing frontend 506 also receives user edits on the event and entity categories, user preferences for alerts and event filters, zone definitions for zones of interest, and the like. The event categorizer 504 optionally revises event categorization models and results based on the user edits received by the user-facing frontend 506. The entity recognition module 326 optionally revises entity classifications and/or labels based on the user edits received by the user-facing frontend 506. The server system 206 also includes databases for storing video source data 510, person data 512, event categorization models 514, and event data and event masks 516. In implementations, the person data 512 is stored in a person database (e.g., the persons database 358). In some implementations, each of these databases is part of the server database 340 (e.g., part of data storage database 330).

The server system 206 receives one or more video stream(s) 508 from the video source 222 and optionally receives event candidate information 518, such as preliminary characterization information for detected entities and events (e.g., entity and event metadata from processing performed at the doorbell device 226), and source information 520 such as device settings for a doorbell device 226 (e.g., a device profile 350 for doorbell device 226). In some implementations, the event processor 502 communicates with the video source 222 and/or one or more other devices of the network environment, e.g., to request additional image data, audio data, and sensor data, such as high-definition images or metadata for the video stream(s) 508. The server system sends alerts for events 522, alerts for detected persons 524, event timeline information 526, and/or video data 528 (e.g., still images or video clips corresponding to the detected persons and/or events) to the client device 228. In some implementations, the alerts distinguish guest approach events from other types of motion events. In some implementations, the alerts distinguish motion events captured at a doorbell device 226 from motion events captured by other smart devices (e.g., cameras 136). The server system 206 optionally receives user information from the client device 228, such as event data 530 (e.g., edits to event categories), and zone definitions 532, and persons data 534 (e.g., classification of detected persons).

A data processing pipeline processes video information (e.g., a live video feed) received from a video source 222 (e.g., including a doorbell device 226 and an optional controller device) and/or audio information received from one or more smart devices in real-time (e.g., within 10 seconds, 30 seconds, or 2 minutes) to identify and categorize events occurring in the network environment, and sends real-time event alerts (e.g., within 10 seconds, 20 seconds, or 30 seconds) and/or a refreshed event timeline (e.g., within 30 seconds, 1 minute, or 3 minutes) to a client device 228 associated with a reviewer account for the network environment. The data processing pipeline also processes stored information (such as stored video feeds from a video source 222) to reevaluate and/or re-categorize events as necessary, such as when new information is obtained regarding the event and/or when new information is obtained regarding event categories (e.g., a new activity zone definition is obtained from the user).

After video and/or audio data is captured at a smart device, the data is processed to determine if any potential event candidates or persons are present. In some implementations, the data is initially processed at the smart device (e.g., video source 222, camera 136, or doorbell device 226). Thus, in some implementations, the smart device sends event candidate information 518, such as event start information, to the server system 206. In some implementations, the data is processed at the server system 206 for event start detection. In some implementations, the video and/or audio data is stored at server system 206 (e.g., in the video storage database 236). In some implementations, the visual/audio data is stored at a server distinct from the server system 206. In some implementations, after a motion start is detected, the relevant portion of the video stream is retrieved from storage (e.g., from the video storage database 236).

In some implementations, the event identification process includes segmenting the video stream into multiple segments then categorizing the event candidate within each segment. In some implementations, categorizing the event candidate includes an aggregation of background factors, entity detection and identification, motion vector generation for each motion entity, entity features, and scene features to generate motion features for the event candidate. In some implementations, the event identification process further includes categorizing each segment, generating or updating an event log based on categorization of a segment, generating an alert for the event based on categorization of a segment, categorizing the complete event, updating the event log based on the complete event, and generating an alert for the event based on the complete event. In some implementations, a categorization is based on a determination that the event occurred within a particular zone of interest. In some implementations, a categorization is based on a determination that the event candidate involves one or more zones of interest. In some implementations, a categorization is based on audio data and/or audio event characterization.

The event analysis and categorization process may be performed by the smart device (e.g., the video source 222) and the server system 206 cooperatively, and the division of the tasks may vary in different implementations, for different equipment capability configurations, power parameters, and/or for different network, device, and server load situations. After the server system 206 categorizes the event candidate, the result of the event detection and categorization may be sent to a reviewer associated with the network environment.

In some implementations, the server system 206 stores raw or compressed video source data 510 (e.g., in the video storage database 236), event categorization models 514 (e.g., in the categorization model database 360), and event masks and other event metadata (e.g., in the event information database 352) for each of the video sources 222. In some implementations, the video data is stored at one or more display resolutions such as 480p, 780p, 1080i, 1080p, and the like.

In some implementations, the video source 222 (e.g., the doorbell device 226) transmits a live video feed to the remote server system 206 via one or more networks (e.g., the network(s) 108). In some implementations, the transmission of the video data is continuous as the video data is captured by the doorbell device 226. In some implementations, the transmission of video data is irrespective of the content of the video data, and the video data is uploaded from the video source 222 to the server system 206 for storage irrespective of whether any motion event has been captured in the video data. In some implementations, the video data is stored at a local storage device of the video source 222 by default, and only video portions corresponding to motion event candidates detected in the video stream are uploaded to the server system 206 (e.g., in real-time or as requested by a user).

In some implementations, the video source 222 dynamically determines at what display resolution the video stream is to be uploaded to the server system 206. In some implementations, the video source 222 dynamically determines which parts of the video stream are to be uploaded to the server system 206. For example, in some implementations, depending on the current server load and network conditions, the video source 222 optionally prioritizes the uploading of video portions corresponding to newly detected motion event candidates ahead of other portions of the video stream that do not contain any motion event candidates; or the video source 222 uploads the video portions corresponding to newly detected motion event candidates at higher display resolutions than the other portions of the video stream. This upload prioritization helps to ensure that motion events of interest are detected and alerted to the reviewer in real-time, even when the network conditions and server load are less than optimal. In some implementations, the video source 222 implements two parallel upload connections, one for uploading the continuous video stream captured by the doorbell device 226, and the other for uploading video portions corresponding to detected motion event candidates. At any given time, the video source 222 determines whether the uploading of the continuous video stream needs to be suspended temporarily to ensure that sufficient bandwidth is given to the uploading of the video segments corresponding to newly detected motion event candidates.

In some implementations, the video stream uploaded for cloud storage is at a lower quality (e.g., lower resolution, lower frame rate, higher compression, etc.) than the video segments uploaded for motion event processing.

As shown in FIG. 5, the video source 222 optionally includes a video doorbell device 226 and an optional controller device 536. In some implementations, the doorbell device 226 includes sufficient on-board processing power to perform all necessary local video processing tasks (e.g., cuepoint detection for motion event candidates, video uploading prioritization, network connection management, etc.), and the doorbell device 226 communicates with the server system 206 directly, without any controller device acting as an intermediary. In some implementations, the doorbell device 226 captures the video data and sends the video data to the controller device for the necessary local video processing tasks. The controller device 536 optionally performs the local processing tasks for multiple cameras. For example, there may be multiple cameras in one network environment (e.g., the network environment 100, FIG. 1), and a single controller device 536 receives the video data from each camera and processes the video data to detect motion event candidates in the video stream from each camera. The controller device 536 is responsible for allocating sufficient outgoing network bandwidth to transmitting video segments containing motion event candidates from each camera to the server before using the remaining bandwidth to transmit the video stream from each camera to the server system 206. In some implementations, the continuous video stream is sent and stored at one server facility while the video segments containing motion event candidates are sent to and processed at a different server facility.

In some implementations, the smart device sends additional source information 520 to the server system 206. This additional source information 520 may include information regarding a device state (e.g., IR mode, auto exposure (AE) mode) and/or information regarding the environment in which the device is located (e.g., indoors, outdoors, night-time, day-time, etc.). In some implementations, the source information 520 is used by the server system 206 to perform event detection, entity recognition, and/or to categorize event candidates. In some implementations, the additional source information 520 includes one or more preliminary results from video processing performed by the video source 222 (e.g., a doorbell device 226), such as categorizations, object/entity recognitions, motion masks, and the like.

In some implementations, the video portion after an event start incident is detected is divided into multiple segments. In some implementations, the segmentation continues until event end information (sometimes also called an “end-of-event signal”) is obtained. In some implementations, the segmentation occurs within the server system 206 (e.g., by the event processor 502). In some implementations, the segmentation comprises generating overlapping segments. For example, a 10-second segment is generated every second, such that a new segment overlaps the prior segment by 9 seconds.

In some implementations, each of the multiple segments is of the same or similar duration (e.g., each segment has a 10-12 second duration). In some implementations, the first segment has a shorter duration than the subsequent segments. Keeping the first segment short allows for real-time initial categorization and alerts based on processing the first segment. The initial categorization may then be revised based on processing of subsequent segments. In some implementations, a new segment is generated if the motion entity enters a new zone of interest.

In some implementations, after the event processor module obtains the video portion corresponding to an event candidate, the event processor 502 obtains background factors and performs motion entity detection identification, motion vector generation for each motion entity, and feature identification. Once the event processor 502 completes these tasks, the event categorizer 504 aggregates all of the information and generates a categorization for the motion event candidate. In some implementations, the event processor 502 and the event categorizer 504 are components of the video processing module 322. In some implementations, false positive suppression is optionally performed to reject some motion event candidates before the motion event candidates are submitted for event categorization. In some implementations, determining whether a motion event candidate is a false positive includes determining whether the motion event candidate occurred in a particular zone. In some implementations, determining whether a motion event candidate is a false positive includes analyzing an importance score for the motion event candidate. The importance score for a motion event candidate is optionally based on zones of interest involved with the motion event candidate, background features, motion vectors, scene features, entity features, motion features, motion tracks, and the like.

In some implementations, the video source 222 has sufficient processing capabilities to perform, and does perform, entity detection, person recognition, background estimation, motion entity identification, the motion vector generation, and/or the feature identification.

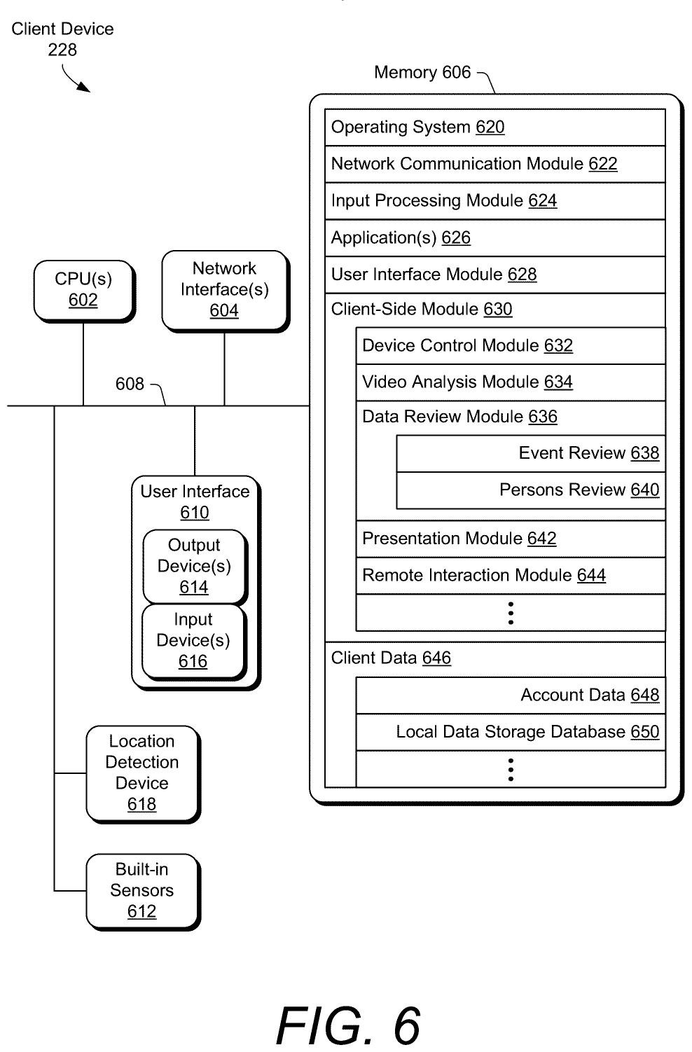

FIG. 6 is a block diagram illustrating a representative client device 228 associated with a user account in accordance with some implementations. The client device 228, typically, includes one or more processing units (CPUs) 602, one or more network interfaces 604, memory 606, and one or more communication buses 608 for interconnecting these components (sometimes called a chipset). Optionally, the client device also includes a user interface 610 and one or more built-in sensors 612 (e.g., accelerometer and gyroscope). The user interface 610 includes one or more output devices 614 that enable presentation of media content, including one or more speakers and/or one or more visual displays. The user interface 610 also includes one or more input devices 616, including user interface components that facilitate user input such as a keyboard, a mouse, a voice-command input unit or microphone, a touch screen display, a touch-sensitive input pad, a gesture capturing camera, or other input buttons or controls. Furthermore, some client devices use a microphone and voice recognition or a camera and gesture recognition to supplement or replace the keyboard. In some implementations, the client device includes one or more cameras, scanners, or photo sensor units for capturing images (not shown). Optionally, the client device includes a location detection device 618, such as a GPS sensor or other geo-location receiver, for determining the location of the client device.

The memory 606 includes high-speed random access memory (e.g., DRAM, SRAM, DDR SRAM, or other random access solid state memory devices) and, optionally, includes non-volatile memory (e.g., one or more magnetic disk storage devices, one or more optical disk storage devices, one or more flash memory devices, or one or more other non-volatile solid state storage devices). The memory 606, optionally, includes one or more storage devices remotely located from one or more processing units 602. The memory 606, or alternatively the non-volatile memory within the memory 606, includes a non-transitory computer readable storage medium. In some implementations, the memory 606, or the non-transitory computer readable storage medium of the memory 606, stores the following programs, modules, and data structures, or a subset or superset thereof:
an operating system 620 including procedures for handling various basic system services and for performing hardware dependent tasks;
a network communication module 622 for connecting the client device 228 to other systems and devices (e.g., client devices, electronic devices, and systems connected to one or more networks 108) via one or more network interfaces 604 (wired or wireless);
an input processing module 624 for detecting one or more user inputs or interactions from one of the one or more input devices 616 and interpreting the detected input or interaction;
one or more applications 626 for execution by the client device (e.g., games, social network applications, smart home applications, and/or other web or non-web based applications) for controlling devices (e.g., sending commands, configuring settings, etc. to hub devices and/or other client or electronic devices) and for reviewing data captured by the devices (e.g., device status and settings, captured data, or other information regarding the hub device or other connected devices);
a user interface module 628 for providing and displaying a user interface in which settings, captured data, and/or other data for one or more devices (e.g., smart devices 204 in network environment 100) can be configured and/or viewed;
a client-side module 630 (e.g., client-side module 230), which provides client-side functionalities for device control, data processing and data review, including but not limited to:
   a device control module 632 for generating control commands for modifying an operating mode of smart devices (and optionally other electronic devices) in accordance with user inputs;
   a video analysis module 634 for analyzing captured video data, e.g., to detect and/or recognize persons, objects, animals, and events, such as described previously with respect to the event analysis module 448;
   a data review module 636 for providing user interfaces for reviewing data from the server system 206 or video sources 222, including but not limited to:
      an event review module 638 for reviewing events (e.g., motion and/or audio events), and optionally enabling user edits and/or updates to the events; and
      a persons review module 640 for reviewing data and/or images regarding detected persons and other entities, and optionally enabling user edits and/or updates to the persons data;
   a presentation module 642 for presenting user interfaces and response options for interacting with the smart devices 204 and/or the server system 206; and
   a remote interaction module 644 for interacting with a remote person (e.g., a guest to the network environment 100), e.g., via a smart device 204 and/or the server system 206; and
client data 646 storing data associated with the user account and electronic devices, including, but not limited to:
   account data 648 storing information related to both user accounts loaded on the client device and electronic devices (e.g., of the video sources 222) associated with the user accounts, wherein such information includes cached login credentials, hub device identifiers (e.g., MAC addresses and UUIDs), electronic device identifiers (e.g., MAC addresses and UUIDs), user interface settings, display preferences, authentication tokens and tags, password keys, etc.; and
   a local data storage database 650 for selectively storing raw or processed data associated with electronic devices (e.g., of the video sources 222, such as a doorbell device 226), optionally including entity data described previously.

Each of the above identified elements may be stored in one or more of the previously mentioned memory devices and may correspond to a set of instructions for performing a function described above. The above identified modules or programs (e.g., sets of instructions) need not be implemented as separate software programs, procedures, modules or data structures, and thus various subsets of these modules may be combined or otherwise rearranged in various implementations. In some implementations, the memory 606, optionally, stores a subset of the modules and data structures identified above. Furthermore, the memory 606, optionally, stores additional modules and data structures not described above.

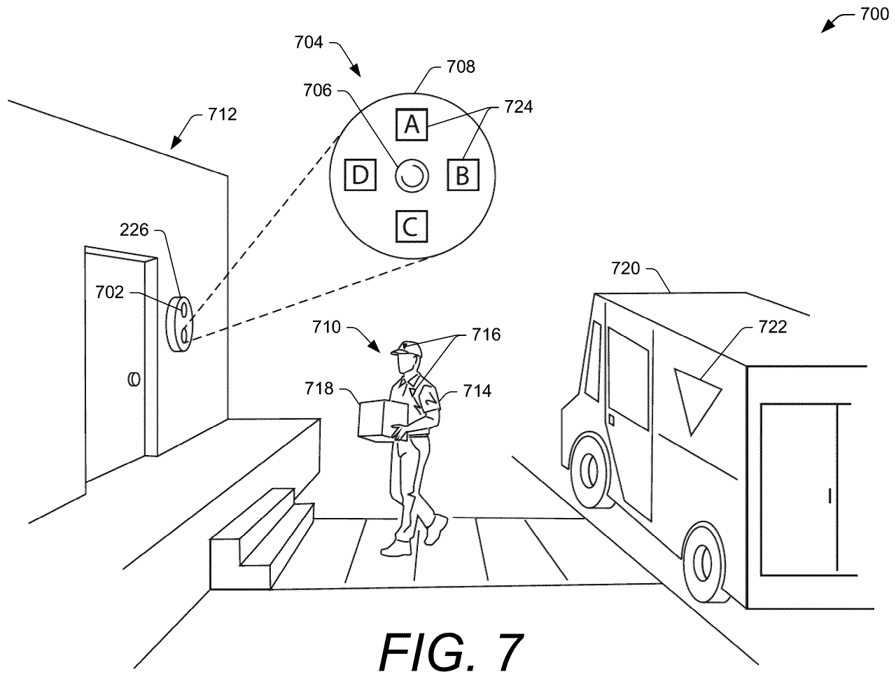

FIG. 7 illustrates an example implementation 700 of an electronic device configured for providing a context-based user interface in accordance with the techniques described herein. The illustration includes an example wireless network device (e.g., smart device 204, video-recording doorbell device 226) having a camera system 702 (e.g., image sensor(s) 408 and associated circuitry). In aspects, the doorbell device 226 also includes a user interface 704 that provides a manner for a user to interact with the device. In one example, the user interface 704 includes a mechanical input device 706 (e.g., pressable button) configured to activate one or more functions, and a display device 708 for displaying content. The camera module 442 of the doorbell device 226 is configured to use the image sensor 408 to capture images and/or video of a scene within a field of view (FOV) of the image sensor 408. In particular, images of a person are captured within the FOV, including a person (e.g., guest 710) approaching the doorbell device 226. As mentioned, the event analysis module 448 of the doorbell device 226 may be configured to use image-processing techniques to identify various objects and/or characteristics of the objects in the captured images. The context sensing module 452 may operate in combination with the characterization module 454 to characterize the guest 710 into a type or category (e.g., mailperson, police officer, solicitor, familiar face, homeowner, generic courier, food delivery person, e-commerce delivery person). The context sensing module 452 is also configured to determine a context (e.g., type of guest and/or their intent for visiting) or estimate multiple possible contexts for the guest 710.

In one example, the doorbell device 226 is a video-recording doorbell mounted on a user's house 712. As the guest 710 (e.g., courier) approaches the doorbell device 226, the camera system 702 can use image-processing techniques to identify one or more characteristics associated with the guest 710, which may be usable by the context-manager module 328 or context sensing module 452 to determine a context of the guest 710. Some characteristics in this example may be associated with the guest's apparel 714, including color, brand, a symbol, or a logo (e.g., logo 716) on the guest's shirt, jacket, pants, hat, or badge, and so forth. Some characteristics may be associated with an object (e.g., object 718) the guest 710 is carrying, including the package wrapping, a label, a symbol, a logo, a color, or any other characteristic usable to identify the guest type as generally a courier, more specifically as a parcel courier, or even more specifically as a parcel courier from a particular company/brand. The guest's voice may be used as a characteristic, such as if the guest 710 audibly indicates what guest type they are (e.g., “Hi, I'm delivering a package from Amazon®”, “I'm here to drop off some pizza,” “Medicine delivery!”). Additional characteristics may be associated with a guest's vehicle 720, if the vehicle is within a field of view of the camera system 702, and may include a symbol, logo (e.g., logo 722), or company name on the vehicle, a type of vehicle (make, model), color, or other characteristic that may be commonly used by a particular company or service. Some characteristics may include whether the guest is a human or a robot (e.g., a drone, robotaxi)

The doorbell device 226 uses the characteristics associated with the guest 710 to determine a context (e.g., guest type) of the guest 710. The context can also be based on additional information obtained from the user of the doorbell device 226. Some example information includes the user's schedule, calendar items, messages, or other information accessible via a wireless network (e.g., user profile). The user's information can be used to provide an indication of whom the user might be expecting to arrive at a particular day and/or time.

Using the context of the guest, the doorbell device 226 can curate and provide context-based options 724 via the user interface 704. The context-based options 724 represent estimations or closest possible reasons for the guest's visit. Some example generic context-based options 802 may include food, parcel, mail, and medicine. The context-based options 724 are provided for the guest's selection to enable the guest 710 to provide input as to the purpose or intent of their visit. The context-based options 724 are dynamic in that the particular context-based options provided via the user interface 704 are associated with the context of the particular guest and/or of the user (e.g., occupant of the house 712) of the doorbell device 226.

In some instances, the determined characteristics may not be sufficient to identify the guest 710. For example, there may be insufficient lighting for the camera system 702 to provide a clear image of the guest 710 or their apparel, the camera system 702 may be disabled or inactive, the camera system 702 may be obstructed, the guest 710 may not be wearing a uniform or identifiable symbol, etc. In such cases, the doorbell device 226 uses the determined context to identify multiple context-based options that each represent a potential purpose for the guest's presence. Using the context helps the doorbell device 226 identify the closest possible options for the type of guest (e.g., a generic courier, a solicitor, a child, medical personnel, a mail person, a medicine courier, a food courier, a parcel courier, a courier from a particular brand/company, a police officer, a firefighter, a friend, a relative, a drone, a robotic transportation (robotaxi)). In one example, if the doorbell device 226 can determine a the type of guest as a generic delivery person but not which company the guest 710 represents, then the doorbell device 226 can provide context-based options 724 that include various delivery companies or more specific guest types, including food delivery and/or e-commerce delivery.

These context-based options 724 are selectable by the guest 710 to enable the guest 710 to indicate their purpose for the visit. After the guest 710 selects the context-based option 724 that best represents their intent for visiting, a notification can be provided (e.g., to notify the user in the home of whom has come to visit and why). In the illustrated example, the context-based options 724 may identify various delivery companies (e.g., companies A, B, C, and D), each of which the user may be expecting to arrive with a delivery. The guest 710 may select, e.g., Company B, and a notification is then provided to the user in the home that a delivery has arrived from Company B. This enables the guest 710 to provide input to indicate their intent when the doorbell device 226 is unable to determine such intent.

In aspects, if both the guest 710 and the brand (e.g., company) can be identified, then the context-based options 724 may include payment options (e.g., pay on delivery (POD), no payment, deferred payment), signature required or not, and so forth. For example, if the guest 710 selects “signature required,” then the user is notified that their signature is required to accept the package being delivered. If the guest 710 selects a POD option, then the user is notified that payment is needed to accept the good(s) being delivered. In another example, the user interface 704 may display text for the guest to read, such as “Signature needed?” along with selectable “Yes” and “No” options for the guest to select. In some implementations, the user (e.g., occupant) inside the house can enter the text on another device (e.g., smartphone), which can transmit the text to the doorbell device 226 for display on the user interface 704. The user can use the other device to transmit the text to the doorbell device 226 in anticipation of the guest's arrival. In another example, the user can interact with the other device to transmit the text to the doorbell device 226 after being notified of the context-based option selected by the guest via the user interface 704. Generally, there may be more context-based options available for display (e.g., pre-stored, updated, and/or machine-learned during operation of the doorbell device 226) than actually displayed based on the determined context. The types and number of context-based options may thus be automatically adapted and, for example, individualized when identifying the guest 710 in the proximity of the doorbell device 226.

The user interface 704 may include a touch-sensitive surface, which is configured to detect and receive touch input by a person's finger or hand. The person (e.g., the guest 710) may scroll through the context-based options 724 using touch input, which may include a swipe or drag gesture (e.g., circular drag motion, a vertical swipe or drag, a horizontal swipe or drag, etc.). As a result, the context-based options 724 are moved across the display device 708. In another example, the user interface 704 may be configured to provide a dynamic tactile surface to form symbols or words (e.g., braille) for a blind or visually impaired guest.

In some aspects, the mechanical input device 706 is integrated with the user interface 704. For example, the user interface 704 may have an annular shape and include the mechanical input device 706 concentrically positioned in the center of the user interface 704. In another example, the user interface may be elongated (e.g., rectangular) and positioned adjacent to the mechanical input device 706.

The mechanical input device 706 may be associated with a chime (e.g., doorbell chime), such that actuation of the mechanical input device 706 activates the chime. Further, the mechanical input device 706 may be powered by battery power or line power. In some aspects, the mechanical input device 706 may be powered by battery power while the user interface is powered by line power.

In implementations, after selecting the context-based option 724, the guest 710 presses the mechanical input device 706 to confirm the selected context-based option and trigger provision of the notification. This two-step input can reduce the likelihood of the guest unintentionally selecting a context-based option that does not represent their intent.

The notification may include an auditory signal, a visual signal, a tactile signal (e.g., vibration), or a human-readable message. For example, a bell (e.g., doorbell) electrically or communicatively connected to the doorbell device 226 may generate an auditory chime. In another example, one or more lights may activate. In another example, the notification may be a text message and/or video transmitted to the user's smartphone or other wireless network device 102 on the HAN 202. The user's smartphone may play an auditory signal (e.g., doorbell chime).

In some aspects, the doorbell device 226 may also be electrically connected to an external power source, which provides line power to the doorbell device 226. In one example, the doorbell device 226 can use the line power for some functions and use battery power for one or more other functions. In this way, a battery-powered function can operate without interfering with a line-powered function.

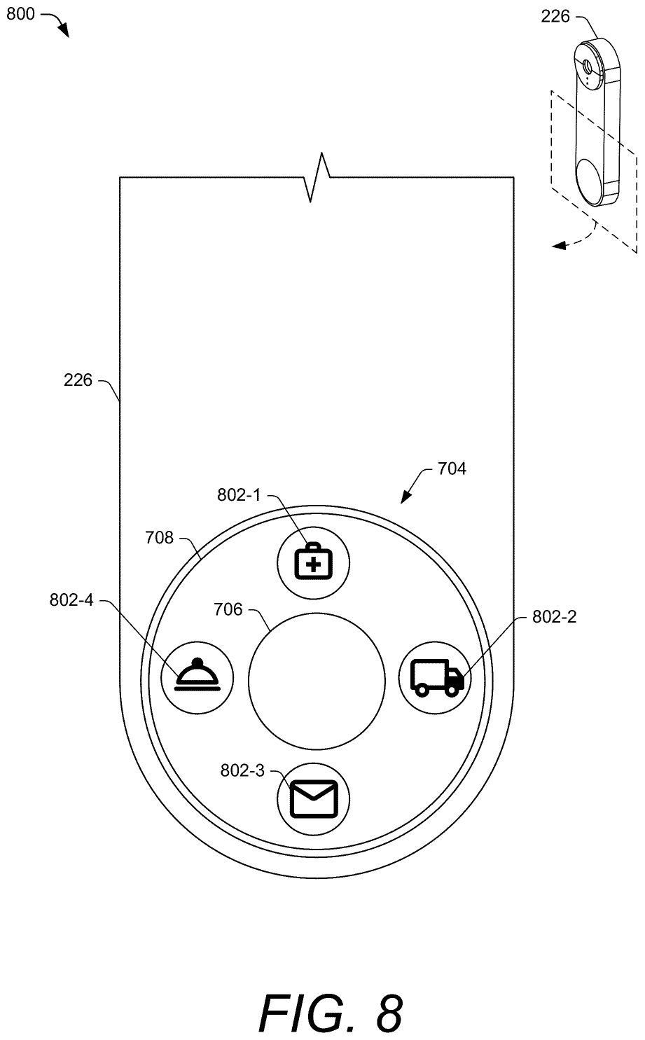

FIG. 8 illustrates an example implementation 800 of an apparatus providing context-based options to a guest. Based on the amount of information the system can obtain pertaining to the context of the guest, the doorbell device 226 may provide different granularities of context-based options (e.g., the context-based options 724 from FIG. 7), from default generic context-based options to specific context-based options, via the user interface 704. In the illustrated example, a guest (e.g., the guest 710 from FIG. 7) is not sufficiently identifiable to estimate their intent for the visit. As a result, the doorbell device 226 provides various generic context-based options 802, which may include medicine delivery 802-1, parcel delivery 802-2, mail 802-3, or food delivery 802-4. The illustrated generic context-based options 802 are merely shown as examples and are not intended to be limiting. Any suitable generic context-based option 802 can be presented via the user interface 704 for selection by the guest. In aspects, the guest can select the displayed context-based option that best represents the purpose for their visit. Any suitable technique can be used to enable the guest to select the desired context-based option, including touch detection, mechanical pressure, a swipe gesture, a scroll gesture, an auditory command, and so forth.

In some aspects, when the guest touches, for example, the parcel delivery 802-2 option, the system determines that the guest is delivering a parcel and may provide a notification corresponding to arrival of a parcel delivery. In another example, selection of the parcel delivery 802-2 option may cause the parcel delivery 802-2 option to be active and, for visual feedback, one or more characteristics (e.g., size, color, line width, shape) of the option may be modified to indicate the selection. The guest 710 may then press the mechanical input device 706 to activate the chime. The chime may be different depending on which context-based option was selected. The chime may be a common bell chime for the home. Pressing the mechanical input device 706 may activate the chime and cause the doorbell device 226 to transmit a notification to the user (e.g., occupant), where the notification indicates the selected context-based option. In this way, the guest interacts with the doorbell device 226 to indicate their intent for visiting and the user in the home is notified of the guest's intent for visiting.

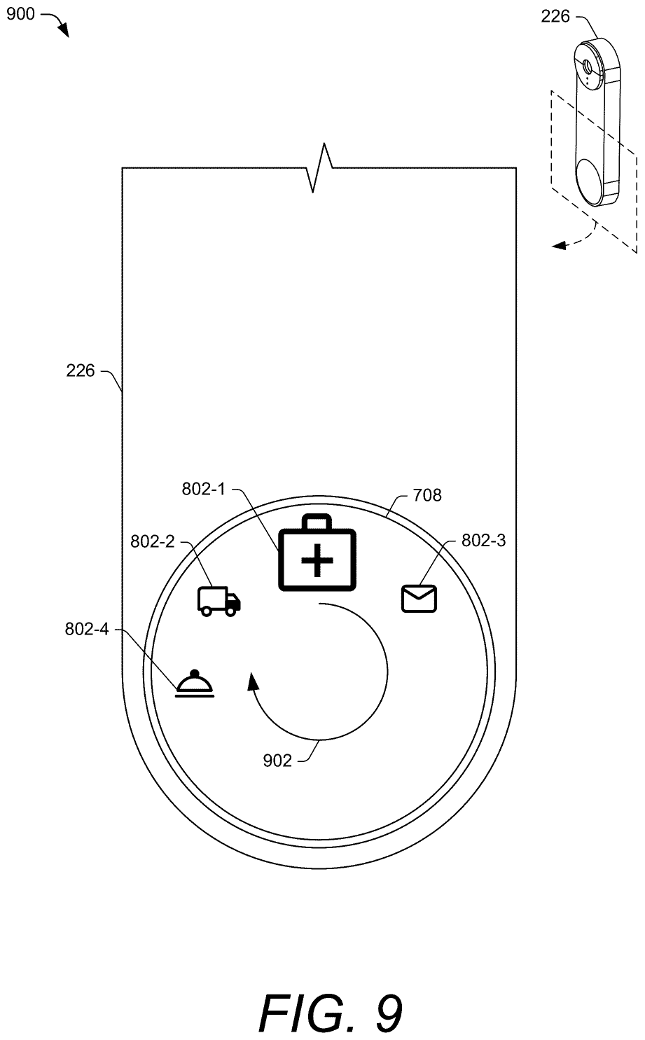

FIG. 9 illustrates another example implementation 900 of an apparatus providing context-based options to a guest. The illustrated example shows an annular-shaped user interface displaying multiple context-based options (e.g., the generic context-based options 802). The context-based options are displayed in a manner that enables the guest to drag their finger in a circular motion (e.g., arrow 902) on the user interface 704. Such a drag gesture causes the context-based options to move in a circular ring around the user interface 704. A particular context-based option located at a particular position (e.g., topmost position, bottommost position, left side, right side) on the user interface 704 may be emphasized (e.g., in size, color, line width, shape) to indicate its selection.

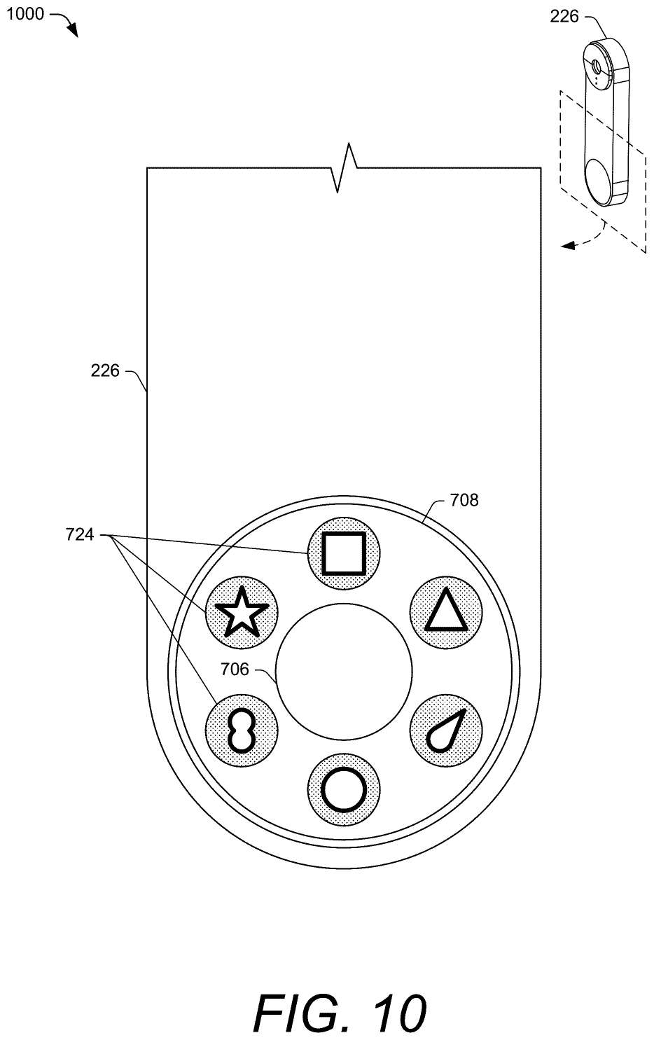

FIG. 10 illustrates another example implementation 1000 of an apparatus providing context-based options to a guest. In this example, the doorbell device 226 has derived a context for the guest or the guest type based on one or more characteristics associated with the guest and/or information obtained from the user in the home. The doorbell device 226 has determined a plurality of context-based options 724 that are based on the determined characteristics associated with the guest. With more characteristics determined, more-specific context-based options can be identified and displayed. In this example, the context-based options 724 include several fairly specific options (e.g., symbols representing particular businesses). Here, the doorbell device 226 has determined that the guest is a delivery courier but has not determined what type of good or service the guest is delivering or to which business the guest belongs. In another example, the doorbell device 226 may determine that the guest is a solicitor but not what type of good or service the guest is selling or offering. Accordingly, the doorbell device 226 can present context-based options 724 in the form of company logos or names (represented in FIG. 10 as generic shapes). Any suitable number of context-based options 724 can be presented. Here, the guest can select the logo of the business they represent and a notification can be sent to the user to indicate the presence of the guest and their intent.

In some implementations, the context-based options 724 may include specific options for emergency personnel. For example, for a guest recognized as being from the fire department, the context-based options 724 may include an emergency evacuation notice, which causes the occupant(s) to be alerted to evacuate the building due to an emergency such as fire or other danger. The options 724 for the firefighter, a paramedic, or a police officer may also include an access request, which alerts the occupant that emergency personnel is requesting access to the house. The occupant can then permit access, via an input to another wireless network device 102, to the home, which may automatically disarm the security system and unlock the door. If the guest is recognized as utility or city services (e.g., plumber, tree trimming crew, yard maintenance crew, electrician, swimming pool technician), the context-based options 724 may include options corresponding to the guest's context. In some cases, the city services personnel may intend to provide service to the exterior of the user's home (e.g., yard, electrical lines, sprinkler system, trees and shrubs), such as by providing pest control, yard services, trimming trees, fixing a broken sprinkler head or pipe, checking electricity box for electricity usage, and so forth. The guest may select a corresponding option to notify the occupant not only that the guest will be on the occupant's property outside the house but also the reason why the guest is present (e.g., what service the guest is providing). In this way, the occupant is notified of the service being performed outside of the occupant's home. Also, the security system may be adjusted to permit the guest's presence.

In some implementations, multiple guests may be detected (e.g., in the field of view of the camera FOV of the image sensor 408). If, for example, two guests are detected simultaneously in the camera FOV, user interface 704 may be a blended interface that is suitable for both guests. In aspects, the context-based options 724 may include one or more options that are common to both guests. In addition or in the alternative, the context-based options 724 may include a combination of options in which one or more options correspond to the one guest's context and one or more other options correspond to the other guest's context. In some aspects, if a first guest approaches before a second guest, the user interface 704 may be populated with context-based options 724 corresponding to the context of the first guest and, after the first guest interacts with the doorbell device 226, the user interface 704 changes to present a different set of context-based options 724 that corresponds to the context of the second guest. In one example, a transportation service (e.g., taxi) may be stopped in front of the house waiting for the occupant while a mailperson approaches to deliver mail for the occupant or a different occupant of the house. In such an example, the user interface 704 may be populated with a combination of context-based options 724 pertaining to the mailperson and the transportation service.

In another implementation, the context-based options 724 may include one or more seasonal-type options. The seasonal-type options may include icons or images corresponding to a current holiday or event occurring in the region. For example, the options displayed may include a particular color, image, shape, theme (e.g., spooky Halloween, festive Christmas, loving Valentines) corresponding to a geographically based holiday. The options may correspond to a state holiday, a federal holiday (e.g., president's day, independence day), or a local city holiday. For example, an option may include an image of fireworks for independence day, a face of the local country's president for president's day, a menorah for Hanukkah, a Christmas tree for Christmas, a turkey for Thanksgiving, etc. The options may include options corresponding to informal localized celebrations, such as a donut for national donut day, a coffee mug for national coffee day, a hamburger for a local neighborhood barbeque, and so forth. Information associated with the holiday or event may be retrieved from the user's user data 3470 (e.g., calendar 3472, social media account 3478, applications 3480) to identify particular holidays and events, or the type of holidays and events, that the occupant is interested in. The occupant can select (e.g., in settings) which seasonal-type options to enable for presentation to the guest via the user interface 704 on the doorbell device 226.

In some implementations, the context-based options 724 may include options to cause different sounds to be provided (e.g., chimed) to the occupant. In this way, different options may enable the guest to select a particular alert (e.g., chime) for the occupant. For example, during the Christmas season, a first selectable option (e.g., bells) may trigger a first chime (e.g., “Jingle Bells”) and a second selectable option (e.g., snowman) may trigger a second chime (e.g., “Frosty the Snowman”). Any suitable icon, including musical notes, may be displayed as corresponding to a particular chime or melody. The chimes and/or melodies may be automatically curated based on the current season or event. The chimes and/or melodies may be preset by the occupant based on user preferences, particular guest type or context, the season, local celebrations and holidays, current events, and so forth. The guest can therefore choose which chime or alert to use to notify the occupant of the guest's presence, thereby enhancing the user experience for both the guest and the occupant. In some implementations, on the occupant's birthday, the context-based options 724 may include an option to alert the occupant with a “Happy Birthday” melody. The occupant may manage settings to restrict such options (e.g., seasonal-based chimes and/or melodies) to be presented only for recognized guests, such as friends and family, or to any welcome guest.

In some implementations, and with appropriate permissions in place by all parties involved, if the guest is recognized as a close friend, a family member, or one of the occupants of the home (e.g., authorized) and the user data 3470 (e.g., calendar 3472, social media account 3478) indicates that it is the recognized guest's birthday today, the context-based options 724 may include one or more hyper-localized options (e.g., personalized greeting such as “Happy Birthday”).

In some implementations, the context-based options 724 may include options for the guest to request refreshment from the occupant. For example, in some locales, it is customary to offer refreshment (e.g., water, milk, coffee) to a visitor. Accordingly, if the context of the guest indicates that the guest is tired (e.g., as indicated by body language, facial expressions, ambient temperature, current weather conditions), the context-based options 724 may include an option indicating an offering of refreshment to the guest. If the guest selects such an option, a message is transmitted to the occupant to notify the occupant that the guest is in need of refreshment. The option may include an option for general refreshment and/or may include an option more-specific refreshment, such as water, milk, coffee, and so forth. Depending on which option the guest selects, the occupant can be notified of the particular option selected by the guest and can then provide the requested refreshment.

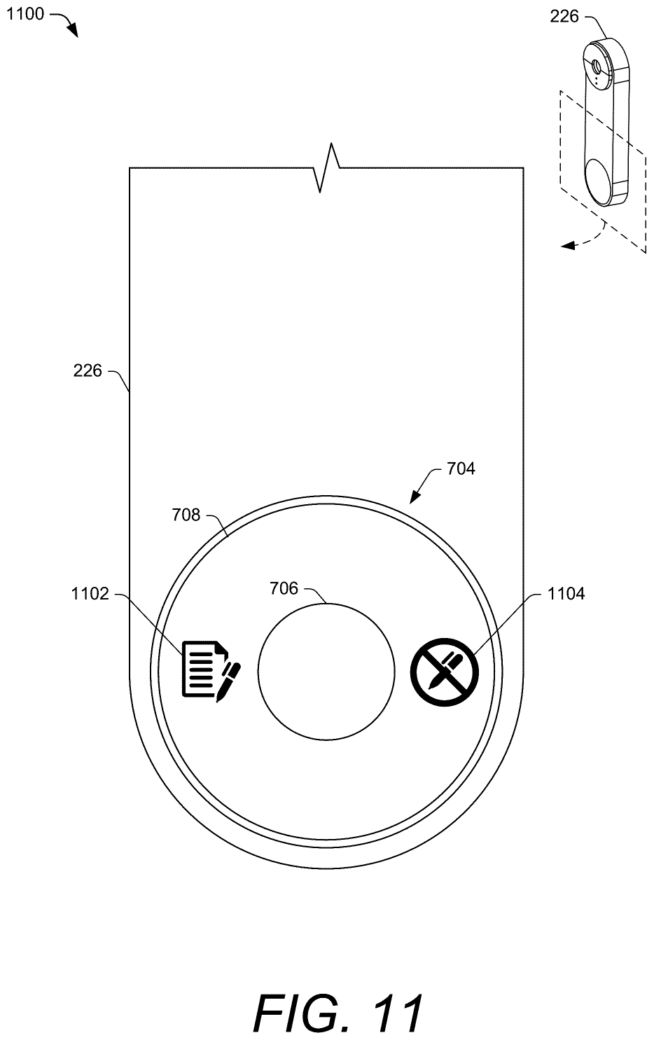

FIG. 11 illustrates another example implementation 1100 of an apparatus providing context-based options to a guest. In this example, the doorbell device 226 determines, based on the characteristics of the guest 710 and/or the information from the user profile 346, that the guest 710 is delivering a good that may or may not require the user's signature. Accordingly, when the guest 710 approaches the doorbell device 226, the doorbell device 226 may present context-based options 724 including a first option 1102 and a second option 1104, where the first option 1102 indicates that a signature is required and the second option 1104 may indicate that no signature is necessary. If the guest 710 selects the first option 1102, then a notification can be sent to the user requesting the user to come to the door to provide the requested signature. If the guest 710 selects the second option 1104, the guest may leave the delivery item at the doorstep and the user is notified that the delivery item was delivered without a signature being required.

In another example, the first and second options 1102 and 1104, respectively, may be presented as secondary options subsequent to a first input by the guest. For example, the doorbell device 226 may first present context-based options, such as generic context-based options 802 (in FIG. 8), when the guest approaches the doorbell device 226. After the guest selects, for example, the parcel delivery option 802-2 (and in some cases the mechanical input device 706), the user interface 704 may then present the first and second options 1102 and 1104, respectively, to enable the guest to input whether a signature is required for the delivery. In some aspects, the occupant is notified, via a wireless network device 102 or the end-user device 168, of the presence of the guest when the guest selects the parcel delivery option 802-2 (and in some cases the mechanical input device 706) and the occupant provides an input to the wireless network device 102 or the end-user device 168 that triggers or commands the doorbell device 226 to present the first and second options 1102 and 1104, respectively. In this way, the guest can interact with the doorbell device 226 to communicate with the occupant, who can interact with another device (e.g., wireless network device 102 or end-user device 168) communicatively connected to the doorbell device 226 to present different options at the doorbell device 226 for selection by the guest.

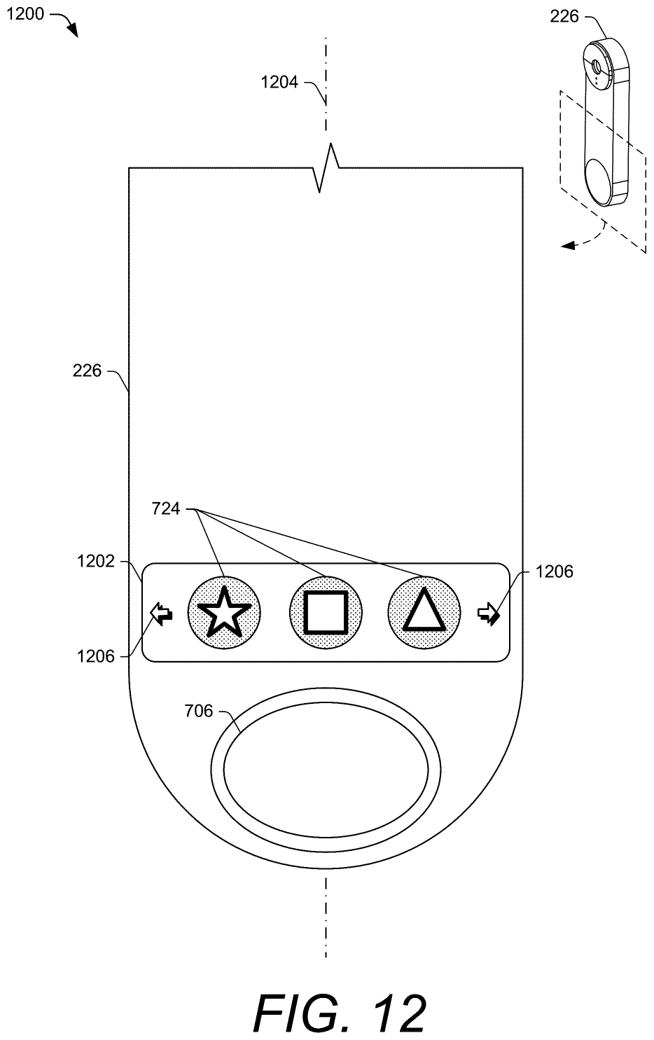

FIG. 12 illustrates another example implementation 1200 of an apparatus providing context-based options to a guest. In FIG. 9, the doorbell device 226 includes an example user interface 1202 (e.g., the user interface 704) positioned proximate to the mechanical input device 706. The user interface 1202 is configured to provide the context-based options 724 in a horizontal arrangement (e.g., orthogonal to a longitudinal axis 1204 of the doorbell device 226). In this way, the guest can scroll horizontally through the context-based options 724 by dragging their finger across the user interface 704 to provide a horizontal swipe gesture (e.g., left swipe, right swipe) or by tapping a directional control (e.g., arrows 1206).

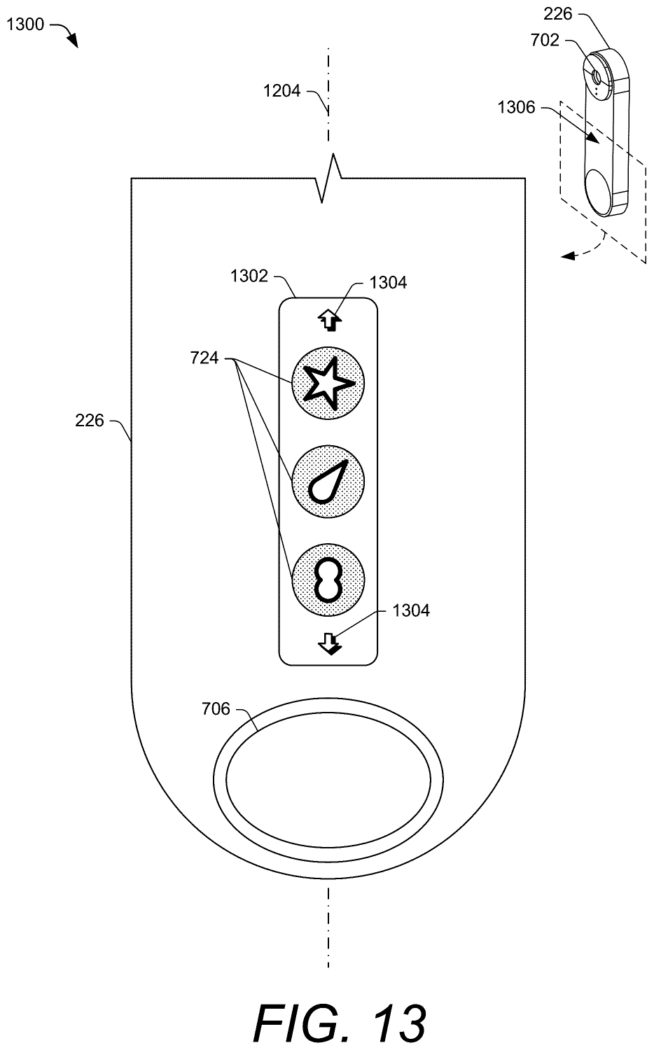

FIG. 13 illustrates another example implementation 1300 of an apparatus providing context-based options to a guest. In FIG. 13, the doorbell device 226 includes an example user interface 1302 (e.g., the user interface 704) positioned proximate to the mechanical input device 706. The user interface 1302 is configured to provide the context-based options 724 in a vertical arrangement (e.g., parallel to the longitudinal axis 1204 of the doorbell device 226). In this way, the guest can scroll vertically through the context-based options 724 by dragging their finger across the user interface 704 to provide a vertical swipe gesture (e.g., up swipe, down swipe) or by tapping a directional control (e.g., arrows 1304). The user interface 1302 may be any suitable size on the doorbell device 226. For example, an area (e.g., region 1306) on the front of the doorbell device 226 between the camera system 702 and the mechanical input device 706 may be used as a display for the user interface 1302 to provide a larger display for presenting the context-based options 724 and receiving the user input from the guest. In some aspects, a menu may be presented via the display with multiple options to choose from.

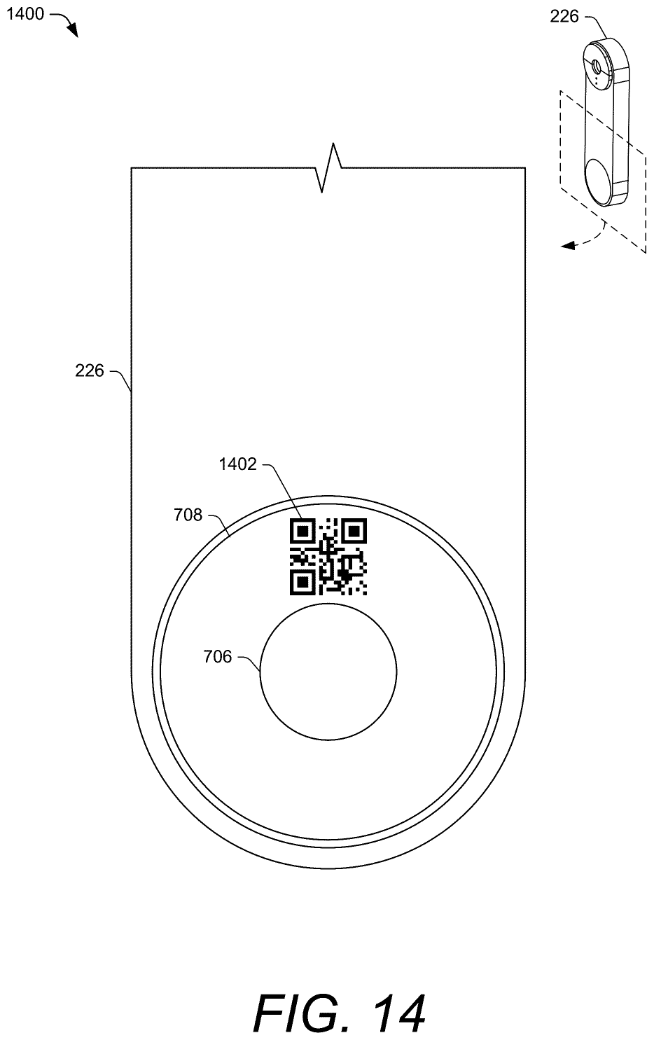

FIG. 14 illustrates another example implementation 1400 of an apparatus providing context-based options to a guest. In this example, the doorbell device 226 may present a machine-readable code (e.g., Quick Response (QR) code 1402, bar code). As the guest approaches the doorbell device 226, if the doorbell device 226 determines that the guest belongs to one of an available (e.g., stored) category and thus type of guest, for example if the doorbell device 226 determines that the guest is a delivery courier but is unable to determine any additional characteristics of the guest to identify more-specific context-based options to display, the doorbell device 226 may present the QR code 1402 (or other machine-readable code). The guest can use their own device (e.g., personal smartphone, company device) to scan the QR code 1402, which may enable the guest's device to communicate with another device associated with the user (e.g., a network-connected device, the user's smartphone, the cloud service 112) to cause the other device to provide the notification (e.g., the chime). In this way, the guest's device acts as a trigger for the doorbell and the user's other device acts as the notifying device.

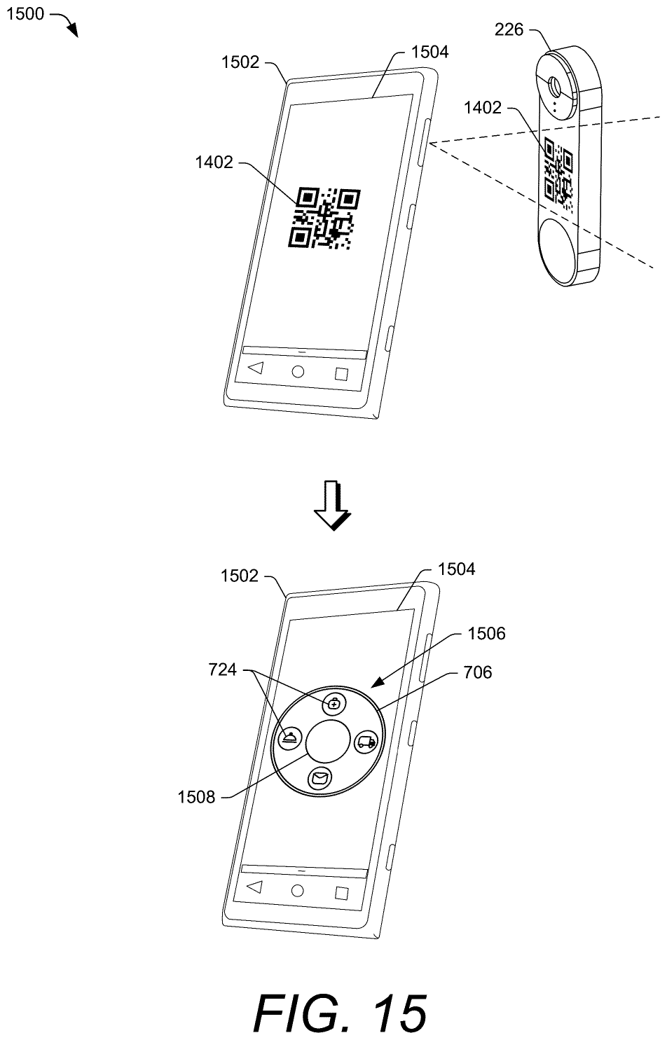

Although this example describes presenting the QR code 1402 via the display, the QR code 1402 may alternatively be included (e.g., printed, adhered, painted) on a housing of the doorbell device 226. In another example, the QR code 1402 may be separate from the doorbell device 226 (e.g., adhered to the user's door or exterior wall of the user's home). An example of this is described in more detail in FIG. 15.

FIG. 15 illustrates another example implementation 1500 of an apparatus providing context-based options to a guest. In this example, the doorbell device 226 includes or presents a machine-readable code (e.g., the QR code 1402). The guest uses their own device (e.g., guest's device 1502) to scan the QR code 1402. In aspects, the guest's device 1502 can display an image of the QR code 1402 via a display device 1504. The QR code 1402 directs the guest's device 1502 to communicate with a server over a network (e.g., a cellular network). Based on such communication, the server transmits to the guest's device 1502 a transmittable version 1506 of the user interface 704 of the doorbell device 226 for display. In aspects, the transmittable version 1506 of the user interface 704 displayed on the guest's device 1502 may include a virtual button 1508 representing the mechanical input device 706 (from FIG. 1) on the doorbell device 226. Further, the guest's device 1502 is supplied with the context-based options 724 for the guest to select to convey the purpose for their visit.

The guest can select one of the context-based options 724 via the guest's device 1502 to indicate their intent for visiting. In some aspects, selection of one of the context-based options 724 causes the guest's device 1502 to transmit a notification to the server, which forwards the message to a wireless network device 102 (e.g., smart device 204, end-user device 168) of the occupant. In other aspects, the guest may select the context-based option and then, to enable correction and reduce potential errors, the guest may confirm their selection by activating the virtual button 1508, which causes the guest's device to transmit the notification. In one example, the QR code may enable the guest's device 1502 to send the notification (selected via the guest's device 1502) directly to the user's device. When the user's device receives the notification, the user's device may produce a chime (e.g., doorbell chime) or other signal to notify the user of the guest's presence and/or the intent of their visit. Accordingly, the guest's device 1502 presents the user interface 704, which is populated with curated, context-based options based on information in the QR code 1402 and/or characteristics of the guest identified by the sensors 412 (from FIG. 4) of the doorbell device 226 (or of another wireless network device 102 in the HAN 202), as well as information obtained from the user data 3470.

In another example, an owner of a short-term rental unit may be expecting a new tenant to be arriving within a particular block of time. When a guest arrives, the doorbell device 226 presents a machine-readable code (e.g., QR code 1402) for the guest to scan on their own mobile device. The QR code 1402 directs the guest's device 1502 to a server, which provides the user interface 704 for display on the guest's device 1502. In this example, the user interface 704 may include a keypad with alphanumeric characters and/or images (e.g., icons). Then, the guest may enter a passcode, obtained from the owner through previous communications, by selecting a sequence of the alphanumeric characters and/or images. The guest's device communicates the guest's selections to the server, which verifies the passcode. The server may then communicate with the rental unit's home area network to cause the network-connected door lock to unlock and enable the guest to access the rental unit. The server may also communicate with the doorbell device 226 to cause the doorbell device 226 to notify the guest that the door is now unlocked and they are welcome to enter (e.g., present a welcome notification). Such a notification may include lights illuminating on the doorbell device 226, a display of an image (e.g., check mark) or text (e.g., “enter,” “ok”), an auditory signal (e.g., chime), or other suitable notification. The server may also communicate the welcome notification to the guest's device 1502 (e.g., via the user interface 704 displayed on the guest's device 1502, via an SMS message, via an email).

Using these techniques, the guest can use their own device to interact with a machine-readable code, which may or may not be located on the doorbell device 226 (e.g., electronic doorbell), to access the context-based options and select one or more of the context-based options to indicate both their presence and intent for the visit.

In another example, the guest may be a drone (e.g., robotic courier), which scans the QR code 1402 to establish communications with the server. The server provides the context-based options 724 to the drone to enable the drone to indicate its intent for visiting. The drone selects one of the context-based options 724 and transmits a notification to the server, which forward the message to the wireless network device 102 of the occupant. Similar to other implementations above, the QR code 1402 may enable the drone to send the notification directly to the user's device.

In some implementations, the context-based options 724 provided by the doorbell device 226 may not apply to the guest. For example, the system may determine incorrect context-based options 724 that do not apply to the guest. In such a scenario, one or more options can be provided to enable the guest to override the currently displayed context-based options 724. In a first example, the guest may simply press the mechanical input device 706 (e.g., doorbell button) to alert the occupant. In another example, the guest may capture an image of the QR code 1402, which directs the guest's device to the cloud service 112 in communication with the doorbell device 226 to request additional context-based options 724 (e.g., via a menu) from the cloud service 112 for the guest to select via the guest's device. In yet another example, the guest can speak their context (e.g., a mailperson can say “mail” or “mailman”) to cause the user interface 704 to present appropriate context-based options 724 for the spoken context. In another example, the displayed context-based options 724 may include a “more” option, which when selected causes additional context-based options to be displayed. As mentioned, the guest may scroll through the context-based options 724, including additional context-based options, by swiping or dragging their finger across the user interface 704. The guest may enter a passcode to call up specific options for display (e.g., a passcode may be associated with a particular company or service). In another example, the guest may carry an on-person electronic element (e.g., electronic key) that provides a signal, which when received by the doorbell device 226, causes the doorbell device 226 to display a particular set of context-based options. Thus, notwithstanding the intelligence of the system, the signal provided by the on-person electronic element essentially requests the doorbell device 226 to display the particular set of context-based options.

In another example, the user interface 704 may include an option for the guest to select to cause the camera system 702 to capture an image and re-determine the context of the guest. Perhaps the camera system 702 failed to capture a sufficiently clear image of the guest's uniform and badge and as a result, determined incorrect context-based options for display. In response, the guest may position their badge in front of the camera system 702 to enable the camera system to, either automatically or in response to an input by the guest, capture a new image (of the badge) and determine new and more appropriate context-based options for display.

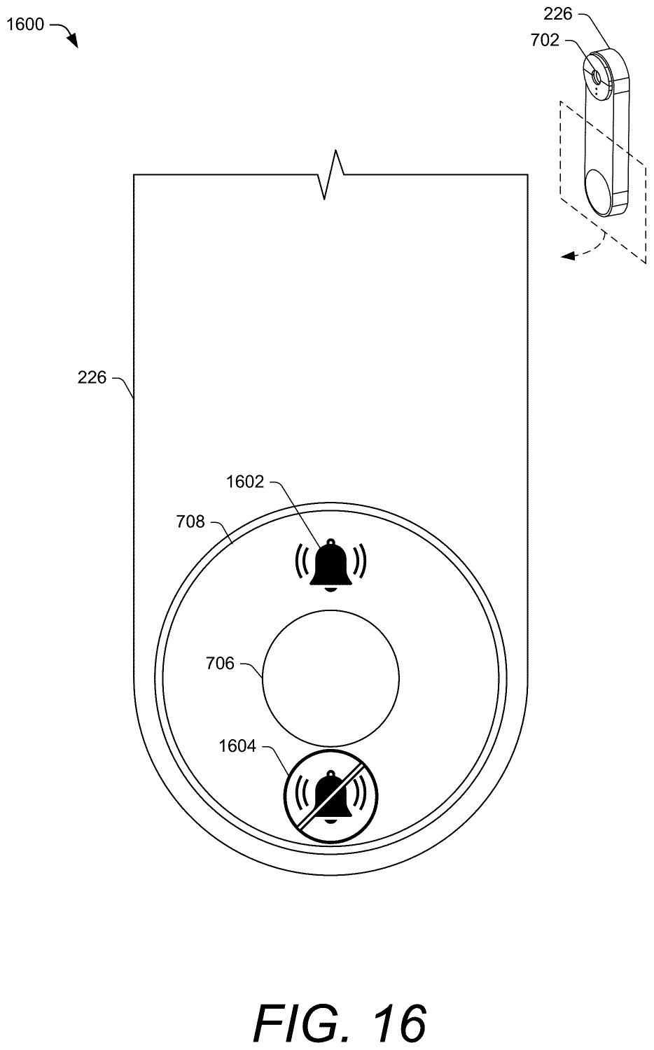

FIG. 16 illustrates an example implementation 1600 of an apparatus providing context-based options to an occupant outside their home. A user (e.g., homeowner) may be outside their house and be unsure as to whether their alarm system is armed or disarmed. This may be due to various conditions, including a lapse in memory by the user, someone else arming the security system, a lack of notification of the arming of the security system to the user, and so on. If the user is outside their house (e.g., watering their plants) and the user passes within range of the doorbell device 226, for example, the doorbell device 226 can recognize the user as the homeowner and curate customized, context-based options for the user. In aspects, the user may be recognized by using multi-factor authentication (e.g., geofence, facial recognition, voice recognition, user carrying a paired device).

In an example, if the guest is recognized as the occupant and thus as a user associated with the doorbell device 226 (and with a certain security level) and being allowed to control aspects of the security system, the doorbell device 226 can present context-based options for arming 1602 and/or disarming 1604 the security system on the house. Additional options—and in particular options different from the ones available and displayed to a person identified as another type of guest—may also be presented, which the user can select in a particular sequence to provide a passcode for disarming the security system and/or unlocking the door to the house. The additional options can include any suitable options, including the context-based options 724 described herein, alphanumeric characters, and so forth. In some implementations, the additional options (e.g., pin pad) may be presented via the user interface 704 in response to selection of the arming 1602 option or disarming 1604 option. Alternatively, the arming 1602 and/or disarming 1604 options may be presented following the user selection of the particular sequence of the displayed context-based options 724 or of the additional options. In some instances, if the guest is determined, via facial recognition techniques, to possibly (with a moderate or low level of confidence) be the occupant, the pin pad or other arrangement of selectable options may be presented via the user interface 704 as a second level of security to the security system requiring entry of the passcode or proper sequence of inputs for disarming the security system and/or unlocking the door to the house. In aspects, if the user selects the arming 1602 option or the disarming 1604 option, the doorbell device 226 can provide a notification of a state change of the security system based on the selection.

In another example, if the guest is recognized (e.g., via multi-factor authentication) as an occupant of the house, the user interface 704 may present a notification that welcomes them home and/or indicates that the door is now unlocked (e.g., the server system 206 uses the guest's context detected by the doorbell device 226 and/or other sensors 412 to (i) determine that the guest approaching the house is the occupant of the house and (ii) direct the network-connected door lock system 148 to unlock).

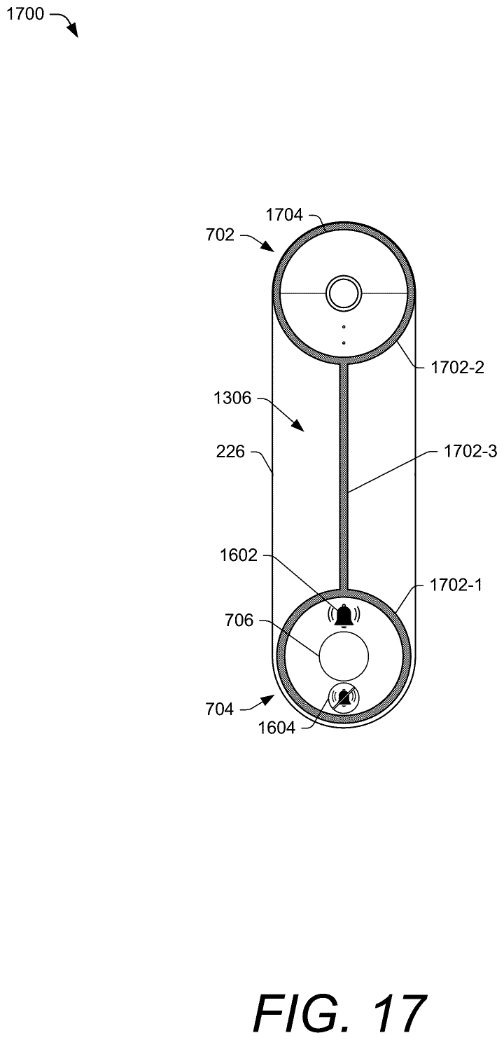

FIG. 17 illustrates an example implementation 1700 of an apparatus providing context-aware notifications to a homeowner or other occupant. As illustrated, the doorbell device 226 includes a light channel 1702 (e.g., light-emitting diodes (LEDs), lighting units 138), which can activate in different ways for different reasons. The light channel 1702 may be positioned in any suitable location on the doorbell device 226 and configured to diffuse light generated by LEDs within the housing of the doorbell device 226. In the illustrated example, the light channel 1702 includes a first portion 1702-1, which includes a circular light ring that circles the user interface 704 and/or the mechanical input device 706. The light channel 1702 may also include a second portion 1702-2, which includes a circular light ring that circles the camera system 702, including a camera cover 1704. Further, the light channel 1702 may include a center path (e.g., third portion 1702-3) connecting the first and second portions 1702-1 and 1702-2, respectively. In aspects, the center path may be located on the left and/or right edges of the front of the device. In some implementations, the light channel 1702 may be a series of separate and individual light sources (e.g., LEDs) (without a diffusing material forming a channel) that provide separate points of light along the exterior surface of the doorbell device 226. In other aspects, if the region 1306 between the camera system 702 and the user interface 704 is a display, such a display may illuminate to provide the lighting notification to the user. In such an example, the display may present text and/or imagery to provide the notification to the user.

The LEDs can be activated in different ways to provide notifications. For instance, if the person in the camera FOV is recognized as the homeowner, the doorbell device 226 may activate the LEDs to notify the homeowner that the security system is armed. Optionally, the arming 1602 and/or disarming 1604 options may also be displayed. In an example, the LEDs may be activated in particular colors and/or flashing patterns indicating whether the security system is armed or disarmed. For instance, if the doorbell device 226 detects the occupant exiting the home and the security system is not armed, the doorbell device 226 may illuminate its LEDs in a particular color, such as a warm color (e.g., red, orange, yellow), and/or flashing/pulsing pattern to catch the occupant's attention and indicate that the security system is not armed. In another example, if the security system is armed, the doorbell device 226 may activate the LEDs in another color, such as a cool color (e.g., green, white, blue), at a solid and steady brightness level to indicate that the security system is armed. Similar indications may be provided when the occupant is approaching and/or entering the home, as is further described herein. Although the lighting units 138 on the doorbell device 226 can be used to notify the homeowner of the status of the security system, these options and lighting notifications may be limited to only specifically identified and authorized guests, including the homeowner, occupants of the home, and/or other familiar faces identified by the homeowner as having permission to arm/disarm the security system. However, such options and lighting notifications may not be presented to persons not recognized as familiar and/or authorized faces, which may help maintain the safety and security of the occupant's home.

In some implementations, the LEDs (e.g., the second portion 1702-2) around the camera system 702 may be used to indicate whether the guest is positioned sufficiently within the camera FOV. For example, if the guest is standing off to one side of the doorbell device 226 and is out of the camera FOV or is only partially detected within the camera FOV, the LEDs may illuminate in a particular color (e.g., red) and/or in a flashing or pulsing pattern. In contrast, if the guest is detected to be in the camera FOV sufficient for the image sensor 408 to capture an image of the guest's face, then the LEDs may illuminate in a different color (e.g., green, blue) and/or in a steady brightness (no flashing or pulsing). In some implementations, LEDs (e.g., the second portion 1702-2) around the camera system 702 may partially illuminate based on a relative location of the guest to indicate whether the guest is standing sufficiently in the camera FOV or not. For example, the second portion 1702-2 may illuminate a full circle around the camera system 702 when the guest is standing sufficiently in the middle of the camera FOV. However, if the guest is standing off to one side (e.g., left side, right side) of the doorbell device 226, then the second portion 1702-2 may illuminate a quarter or half of the circle that corresponds to the side on which the guest is positioned. In this way, the guest may see that the second portion 1702-2 brightens or darkens based on the guest's position relative to the doorbell device 226 and may intuitively understand that the second portion 1702-2 fully illuminates (full circle) around the camera system 702 when the guest stands in a particular location in front of the doorbell device 226.

In some implementations, the LEDs may be used to notify the guest that the guest's presence has been detected and that the occupant is automatically being notified of the guest's presence (e.g., without the guest pressing the mechanical input device 706). For example, a transportation-service vehicle (e.g., robotaxi) may arrive and stop in front of the user's house or in the user's driveway. The doorbell device 226 may detect the vehicle's context as corresponding to the transportation service, particularly if the user data 3470 indicates that the occupant is expecting the transportation-service vehicle to arrive at or near a particular time of the day. Without establishing a wireless communication link with the vehicle, the doorbell device 226 may activate the LEDs (e.g., high illuminance and color) to provide an indication that the vehicle's presence has been detected. The LEDs may be activated in a steady, solid color and brightness or may be activated in a particular flashing or pulsing pattern. The activation of the LEDs may indicate to the driver of the vehicle (whether human or robotic) that the vehicle's presence is detected and the occupant is being notified accordingly. The doorbell device 226 may automatically alert the occupant (e.g., via another network-connected device of the occupant). In some instances, the occupant may access an application on their other network-connected device (e.g., smartphone or other wireless network device 102 on the HAN 202) to initiate a communication to a server of the transportation service, which may relay a message to the vehicle stopped outside of the occupant's home. Accordingly, through the application (“app”), the occupant may communicate a message the driver (human or computerized) vehicle that the occupant is “on my way,” “will be there in five minutes,” and so forth.

In another example, the LEDs may be used to notify the guest of a communication error or device malfunction in attempting to notify the occupant of the guest's presence. For example, after the guest presses the mechanical input device 706, if a communication link between the doorbell device 226 and the network 108 is not active and/or cannot be established, the doorbell device 226 may illuminate the LEDs to notify the guest. The LEDs may be illuminated in any suitable manner to indicate the error, including using a particular color (e.g., red) with high illuminance and/or a flashing pattern. In some implementations, the user interface 704 may display an error message for the guest. In some implementations, the user interface 704 may display a message that directs the guest to knock on the door instead. Accordingly, the guest can be notified by the doorbell device 226 of whether the doorbell notification can or cannot reach the occupant due to a communication error, so the guest understands that the occupant is unaware of the guest's presence and is not coming to answer the door. This enhances the user experience for the guest because the guest does not have to spend time waiting for the occupant to come to the door when the occupant is not actually coming due to the communication error.

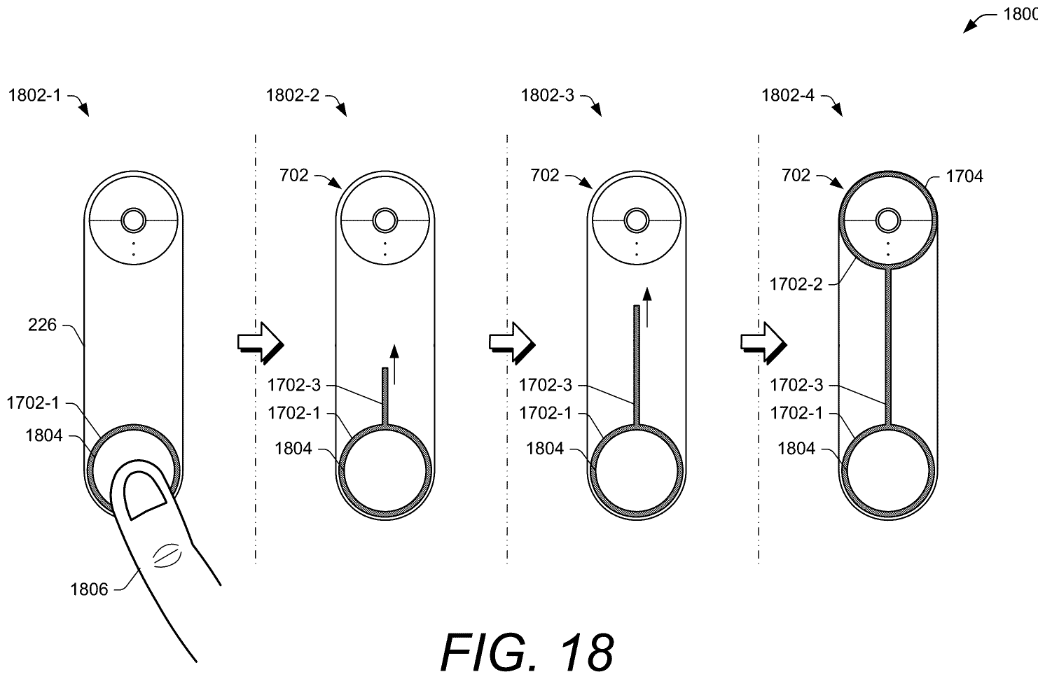

FIG. 18 illustrates an example implementation 1800 of an apparatus configured to provide context-aware notification to a guest. Some network-connected systems have a delay between when the doorbell button is pressed by a guest and when a notification (e.g., audio signal) is provided by a network-connected device (e.g., wireless network device 102) inside the occupant's house. If the guest does not hear an audio signal (e.g., chime) after pressing the doorbell button, the guest may not know if the user has been notified of the guest's presence. In this case, there is not a way for the guest to know whether pressing the doorbell button succeeded or failed in signaling the occupant.

In some implementations, a progress indicator (e.g., the light channel 1702) can be provided by the doorbell device 226 to the guest to communicate the latency or the progress from the time the guest pressed the doorbell button to when the occupant is signaled. For example, in the illustrated implementation 1800, the doorbell device 226 is shown in various stages 1802 (e.g., a first stage 1802-1, a second stage 1802-2, a third stage 1802-3, and a fourth stage 1802-4) of communicating the latency.

In the first stage 1802-1, the guest presses a doorbell button 1804 (e.g., mechanical input device 706), which may be integrated with the user interface (e.g., the user interface 704) described herein. In the illustration, the guest presses the button 1804 with their finger 1806. In response to the button 1804 being pressed, the first portion 1702-1 (e.g., circular light ring) of the light channel 1702 is activated and illuminates around the button 1804, providing visual feedback to the guest to indicate successful initiation of a transmission of a signal to the occupant (or to a wireless network device 102 of the occupant).

As illustrated in the second stage 1802-2, a strip of light (e.g., the third portion 1702-3) is activated in a sequence beginning at the first portion 1702-1 (around the button 1804) and ending at the camera system 702. To the guest, the third portion 1702-3 may appear as a line extending over time from the button 1804 toward the camera system 702. In aspects, the third portion 1702-3, which may be a strip of lights, extends at a rate that corresponds to an estimated latency between actuation of the button 1804 and when the occupant is notified of the actuation. In some implementations, the rate at which the light extends from the first portion 1702-1 toward the second portion 1702-2 along the third portion 1702-3 substantially matches a speed of the communication occurring between the doorbell device 226 and a wireless network device 102 in the occupant's house. In the third stage 1802-3, the third portion 1702-3 has progressed farther toward the camera system 702, indicating further progression of the communication.

In the fourth stage 1802-4, the third portion 1702-3 has reached the camera system 702 and the second portion 1702-2 (circular light ring) of the light channel 1702 is activated to illuminate around the camera system 702, indicating confirmation that the occupant has been notified of the button press. In some implementations, the second portion 1702-2 lighting up may indicate that the occupant has accessed a video feed being captured by the camera system 702. In this way, the guest may know that the occupant can “see” the guest via the camera system 702.

In some aspects, the progress indicator (e.g., the light channel 1702) illuminates, progressing from the button 1804 toward the camera system 702, to denote the arrival of the occupant of the house at the door where the guest is waiting. For example, the progress indicator can progress from the button 1804 toward the camera system 702 as the occupant is approaching the door from inside the house. In this way, the guest can be informed that the occupant is moving toward the door and will arrive soon. In another example, the progress indicator may first progress from the button 1804 toward the camera system 702, representing the time lapse between the guest pressing the button 1804 and the occupant being notified of the button press, and then progress (e.g., circle) around the camera system 702 representing the estimated time until the occupant arrives at the door. In aspects, these functionalities may be limited to “known” guests (e.g., familiar or recognized faces and/or voices, authorized guests) to maintain the occupant's safety and privacy.

In some implementations, the system (e.g., cloud service 112) can use machine-learning techniques to learn the occupant's typical movements via one or more sensors connected to the HAN 202. In one example, average footsteps, counted from different locations in the house to the door, may be used (in a machine learning model) to estimate an amount of time for the occupant to arrive at the door from a particular room in the house. In aspects, the occupant's footsteps can be counted via the occupant's wearable device (e.g., smartwatch) or smartphone (if being carried by the occupant) relative to the location of the doorbell, with wireless connection strength (between the doorbell and the wearable device/smartphone) increasing as the occupant approaches the doorbell's location near the door. A variety of sensors can be used to detect the occupant's relative location in the house, including ultra-wideband (UWB), radar, motion sensing, camera(s), audio sensors, and so on. Such sensors can be used to detect the occupant's location relative to the doorbell (e.g., distance from the doorbell to the occupant or to a room in which the occupant is located) when the guest presses the doorbell button. The occupant's location may be detected as a general presence in a particular region or room of the house. Such relative location or distance from the doorbell can then be used to estimate the amount of time likely to lapse until the occupant arrives at the door to open it, where the estimate is based on previous measurements (input into a machine learning model) of amounts of time it took for the occupant to move to the door from the particular region or room of the house. This estimated amount of time can be represented by the progress indicator on the doorbell device 226 without actually following the occupant's movements inside the house or without indicating the occupant's location in the house. In this way, the occupant's movements are not actually tracked within the house. Rather, the system estimates how long it is likely to take the occupant to reach the door based on their relative location or distance from the doorbell and how long it typically takes the occupant to arrive at the door from that relative location or distance.

In some implementations, the estimation may be based on historical information learned (e.g., using a machine learning model) over time by the system of how long it takes the occupant to answer the door from that relative distance or location. For example, an occupant located in the kitchen may take, on average, 35 seconds to arrive at the door after being notified of the guest's presence (e.g., via an audio signal). Accordingly, the progress indicator may progressively illuminate the light channel beginning at the button 1804 and ending at the camera system 702 over a time period of 35 seconds. In another example, an occupant located in the study may take, on average, 22 seconds to answer the door. Then, the progress indicator can progress from start to finish over a time period of 22 seconds. Accordingly, the progress indicator may be dynamic in that it is adapted to the occupant's average time taken to answer the door from a particular region or room in the house. In this way, the progress indicator does not represent a static duration of time but is dependent on the occupant's general location in the house relative to the doorbell device 226.

Additional factors may be combined with the occupant's relative location to adjust the estimated amount of time for the occupant to move to the door, including a current activity of the occupant or a device in the same room as the occupant. For example, the occupant may be in the living room with the television on, indicating that the occupant is likely engaged in watching the television and may be slower to react to the doorbell notification than they would if the television were off. Another example may include the occupant in the kitchen with a particular appliance running (e.g., blender, stove, microwave), indicating that the occupant may be slower than usual in answering the door. In another example, if the occupant is in a bedroom, the occupant may be asleep and is not likely to react to the doorbell notification to answer the door. Any suitable additional factor may be combined with the occupant's relative location to estimate the amount of time likely to lapse for the occupant to answer the door.

As mentioned, to maintain the privacy and safety of the occupant, the progress indicator may be presented only to a recognized guest who is approved by the occupant (e.g., in system settings). In this way, the occupant maintains control of the dissemination of such information to specific guests.

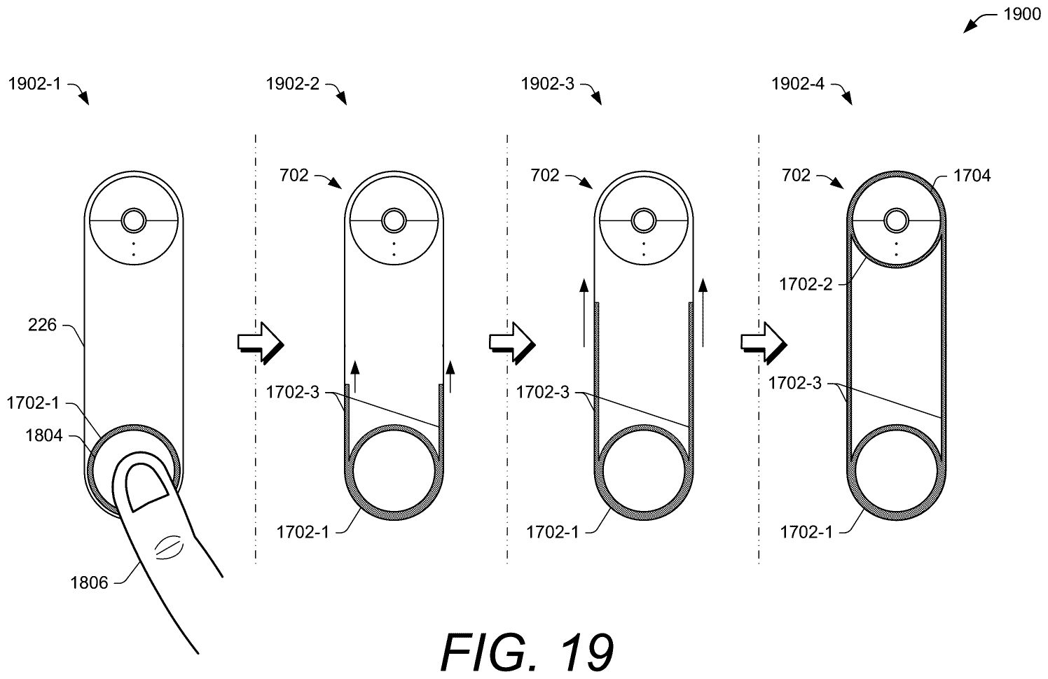

FIG. 19 illustrates another example implementation 1900 of an apparatus configured to provide context-aware notifications to a guest. The implementation 1900 includes various stages 1902 (e.g., a first stage 1902-1, a second stage 1902-2, a third stage 1902-3, and a fourth stage 1902-4) of communicating the latency. Similar to the implementation 1800 in FIG. 18, the first stage 1902-1 includes a guest pressing the doorbell button 1804 with their finger 1806. In response to the button 1804 being pressed, the first portion 1702-1 (e.g., circular light ring) of the light channel 1702 illuminates around the button 1804, providing visual feedback to the guest of successfully initiating transmission of a signal to the occupant (or to a wireless network device 102 of the occupant).

In the second stage 1902-2 and the third stage 1902-3, multiple strips of light (e.g., the third portion 1702-3) begin to illuminate and appear as multiple lines extending over time from the button 1804 toward the camera system 702. Similar to other implementations described herein, when the multiple lines reach the camera system 702 (e.g., the fourth stage 1902-4), the second portion 1702-2 (circular light ring) illuminates around the camera system 702, providing an indication that the occupant (i) has been notified of the button press, (ii) has access to the video feed being captured by the camera system 702, or (iii) is estimated to arrive, from inside the house, at the door where the guest is waiting. Any combination of features of FIGS. 18 and 19 can be implemented. In another example, the progress indicator may first progress from the button 1804 toward the camera system 702, representing the time lapse between the guest pressing the button 1804 and the occupant being notified of the button press, and then progress (e.g., circle) around the camera system 702 representing the estimated time until the occupant arrives at the door.

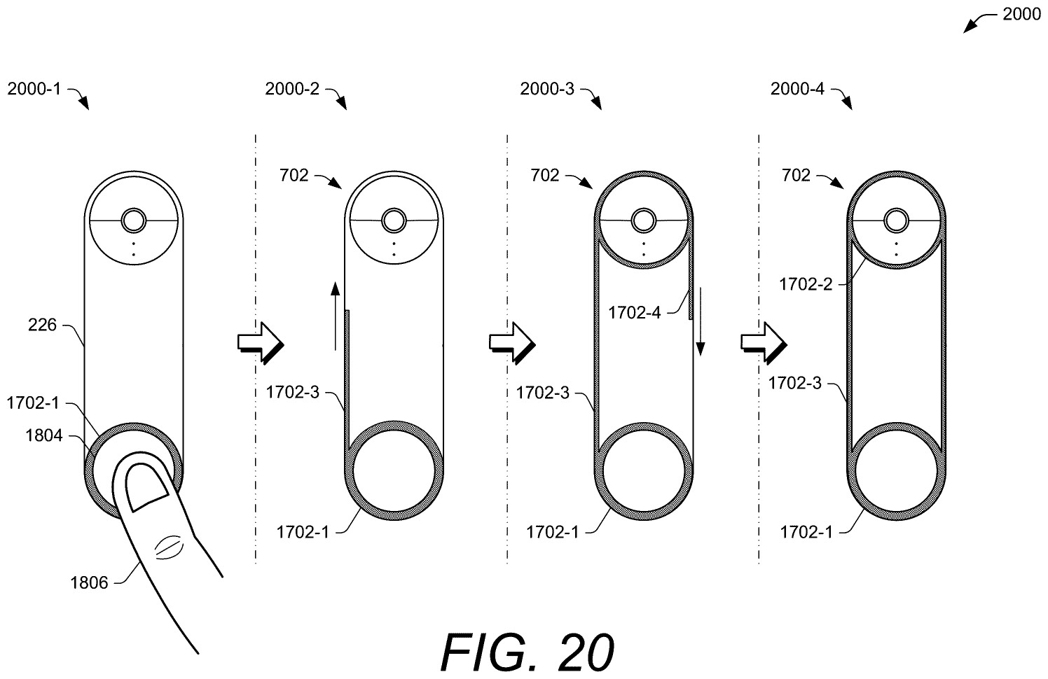

FIG. 20 illustrates another example implementation 2000 of an apparatus configured to provide context-aware notifications to a guest. The implementation 2000 is shown in various stages 2002 (e.g., a first stage 2002-1, a second stage 2002-2, a third stage 2002-3, and a fourth stage 2002-4) of communicating the latency. Here, the progress indicator (i) illuminates the first portion 1702-1 when the button 1804 is pressed (e.g., shown in the first stage 2002-1) and (ii) progresses along the third portion 1702-3 toward the camera system 702 along one side (e.g., left or right side) of the doorbell (e.g., shown in the second stage 2002-2). In the third stage 2000-3, the progress indicator illuminates the second portion 1702-2 when the occupant accesses the video feed being captured by the camera system and then progresses back toward the button 1804 along the other side of the doorbell (e.g., fourth portion 1702-4) according to the estimated time for the occupant to arrive at the door, which is represented by a the fourth stage 2002-4. In this way, the guest is notified of a first latency between the button press and the occupant accessing the camera system, as well as a second latency between the occupant being notified of the guest's presence and the occupant's arrival at the door to open it.

In some implementations, if the guest is not recognized, the doorbell device 226 may request information from the guest in order to determine or estimate the context of the guest. For example, the device may ask the guest to face the camera system 702 and permit the camera system 702 to capture an image of the guest's face, state their name, state their company name, and/or state the nature or intent of their visit. In some implementations, the guest may be requested to state the name of the occupant the guest wishes to visit.

If the guest is recognized as a person designated by the occupant as unwelcome (e.g., an unwelcome guest), the doorbell device 226 may present a blank user interface or context-based options 724 specific to that type of guest, including a text message, flashing lights, a recording played back, or any other indicator that deters the unwelcome guest or notifies the unwelcome guest that the occupant does not wish to accept their visit. Such context-based options may be presented automatically in response to recognition of the guest as an unwelcome guest. In another example, when the occupant is alerted to the presence of the guest, the occupant may provide an input to a device connected to the HAN 202 indicating that the guest is unwelcome or that the occupant does not wish to receive the guest's visit. Then, responsive to the input by the occupant, the user interface 704 displays the context-based options associated with the unwelcome guest to notify the guest that the occupant does not wish to come to the door at the moment. In some instances, the user interface 704 can present a message asking the guest to leave.

In some implementations, when the guest is determined to be an unwelcome guest or a suspicious person (e.g., potential thief or person with possible ill-intent), the doorbell device 226 may present a pin pad or other security-related content via the user interface 704 (e.g., displayed text and/or images) that indicates to the guest that a security system exists and is armed. This may be helpful in instances where the user (e.g., homeowner) is not recognized by the system (or is recognized with only a low level of confidence) because the user can then enter the proper passcode or sequence of inputs to disarm the security system.

In some implementations, the guest may be recognized as a known “bad actor” (via facial recognition compared with police enforcement databases or known images of people associated with e.g., a restraining order, behavioral analysis, social information such as a social sharing security application with information associated with bad actors shared by neighbors). If the guest is recognized as a bad actor, the context-based options 724 may include options corresponding to an unwelcome guest, as described above, whereas additional information can be provided to the occupant, including a notification that the guest is likely a bad actor. The additional information provided to the occupant may include the information (e.g., police information, behavioral analysis, social information from neighbors) indicating the guest to be a likely bad actor. In addition, the security system can increase its current security level (e.g., activating lights, locking doors and windows, activating additional security cameras) due to the likelihood of the guest posing a risk of danger.

### Example Methods

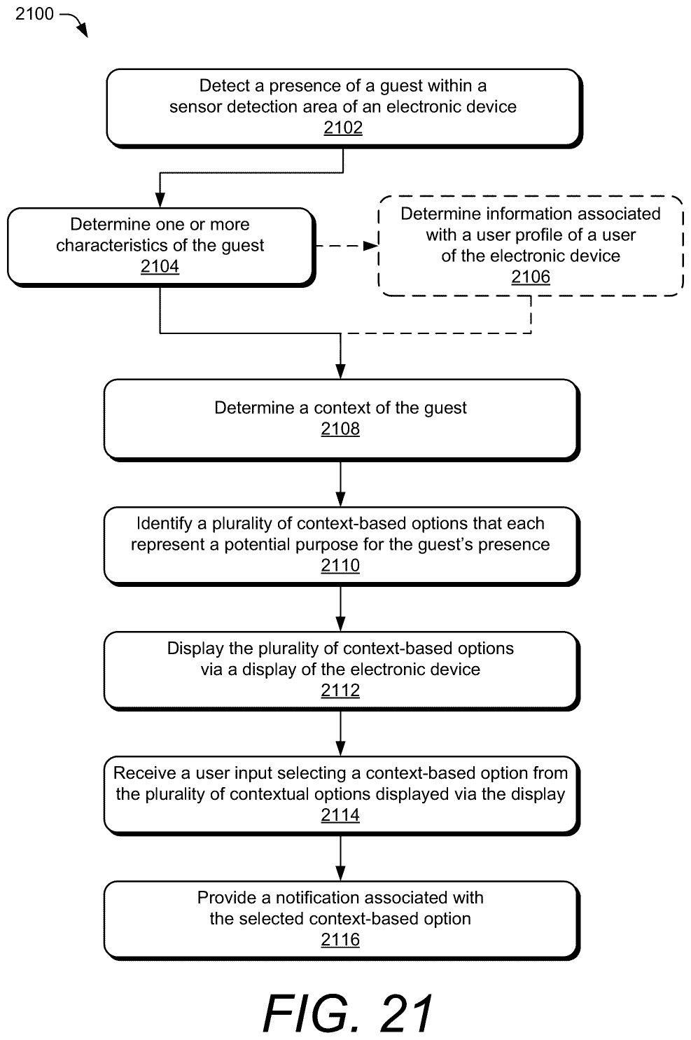

FIG. 21 depicts an example method 2100 for providing context-based options to a guest. The method 2100 can be performed by the wireless network device 102, which uses at least the context sensing module 452 and/or the characterization module 454 to implement the described techniques. The method 2100 provides an enhanced user experience for both an owner of the wireless network device 102 (or occupant of a home on which the wireless network device 102 is installed) and a guest that interacts with the wireless network device 102 (e.g., doorbell device 226).

The method 2100 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example environment 100 of FIG. 1 or to entities or processes as detailed in FIGS. 2-20, reference to which is made for example only. The techniques are not limited to performance by one entity or multiple entities operating on one device.

At 2102, a presence of a guest is detected within a sensor detection area of an electronic device. For example, the electronic device (e.g., wireless network device 102, smart device 204) may include the camera system 702 configured to capture images of a scene within a detection area (e.g., field of view). The electronic device may include one or more audio sensors configured to detect audio signals (e.g., a voice of the guest 710). Also, the electronic device may include radar sensors configured to detect motion of an object (e.g., human) within the field of view of the sensor.

At 2104, one or more characteristics of the guest are determined. For example, the electronic device detects one or more characteristics (e.g., apparel, badge, logo) of the guest 710. The electronic device may capture a voice of the guest 710, one or more images of the guest 710 and/or the guest's vehicle. The characteristics may include any suitable characteristic usable to identify or estimate the type of guest. For example, the characteristics may be associated with the guest's apparel (e.g., uniform, color, brand, symbol, logo, badge), an object the guest is carrying (e.g., package wrapping, label, symbol, logo, brand, color), the guest's vehicle (e.g., make, model, color, symbol, logo), the guest's voice (e.g., voice command or phrase that identifies the type of guest).

Optionally, at 2106, information associated with a user profile of a user (e.g., occupant in the building) associated with the electronic device may be determined. For example, the electronic device can access the user data 3470 via the network 108 to evaluate the user's digital calendar (e.g., the calendar 3472) for expected and/or scheduled visitations. The electronic device can also access the user profile 346 to evaluate the user's email messages 3474, SMS messages 3476, social media account 3478, and/or apps 3480 that the user uses, in order to identify information that may indicate whether the user is expecting a visit and from whom.

At 2108, a context of the guest is determined based on the one or more characteristics. For example, the context sensing module 452 determines the context (e.g., guest type) of the guest 710. The determined or estimated context may be any suitable level of specificity based on identifiable characteristics of the guest 710. Some example contexts of the guest 710 may include a generic courier, a solicitor, a child, medical personnel, a mailperson, a medicine courier, a food courier, a parcel courier, a courier from a particular brand/company, a police officer, a firefighter, and so forth.

At 2110, a plurality of context-based options are identified that each represent a potential purpose for the guest's presence. The characterization module 454 determines generic or specific context-based options based on the level of specificity of the determined or estimated context. For example, if the guest 710 is identified as a generic courier, then the characterization module 454 may select default, generic context-based options 802. If, however, the guest 710 is identified more-specifically as a parcel courier from a particular company (e.g., Amazon), the identified context-based options 724 may include parcel type, parcel size, request for signature, no signature required, and so forth. If, for example, the guest 710 is identified as emergency personnel (e.g., police officer, paramedic, firefighter) and the user data 3470 indicates that the occupant recently (e.g., within the last 10 minutes) called or sent a message to emergency services requesting immediate assistance, then the identified context-based options 724 may include an option for the emergency personnel to disarm (or bypass) the security system and/or unlock the door to enable the emergency personnel to enter the house.

At 2112, the plurality of context-based options are displayed via a display of the electronic device. For example, the context-based options 724 are displayed in the user interface 704 via the display device 708 of the electronic device. The context-based options 724 may be displayed in any suitable arrangement, including the example implementations described in FIGS. 7 to 17.

At 2114, a user input selecting a context-based option from the plurality of context-based options displayed via the display is received. For example, the guest 710 selects one of the displayed context-based options 724 on the electronic device. Accordingly, the electronic device receives a user input from the guest 710 selecting the context-based option 724 that represents the guest's intent for their visit. In some implementations, the electronic device receives a first user input that selects one of the context-based options 724 and then receives a second user input that actuates the mechanical input device 706. Actuating the mechanical input device 706 can activate a chime (e.g., ring a bell) to notify the occupant in the building of the guest's presence and/or of the guest's intent for visiting. In one example, actuating the mechanical input device 706 can cause a notification to be transmitted to another device associated with the occupant in the building, where the notification corresponds to the selected context-based option.

At 2116, a notification associated with the selected context-based option is provided. The notification may be an auditory chime. In implementations, different chimes may be used for different context-based options. For example, a first context-based option may be associated with a first chime whereas a second context-based option may be associated with a second, different chime. A particular chime may indicate a particular type of guest. In some aspects, the notification may be a human-readable message transmitted to another device (e.g., smartphone, appliance, television, tablet) associated with the occupant of the building.

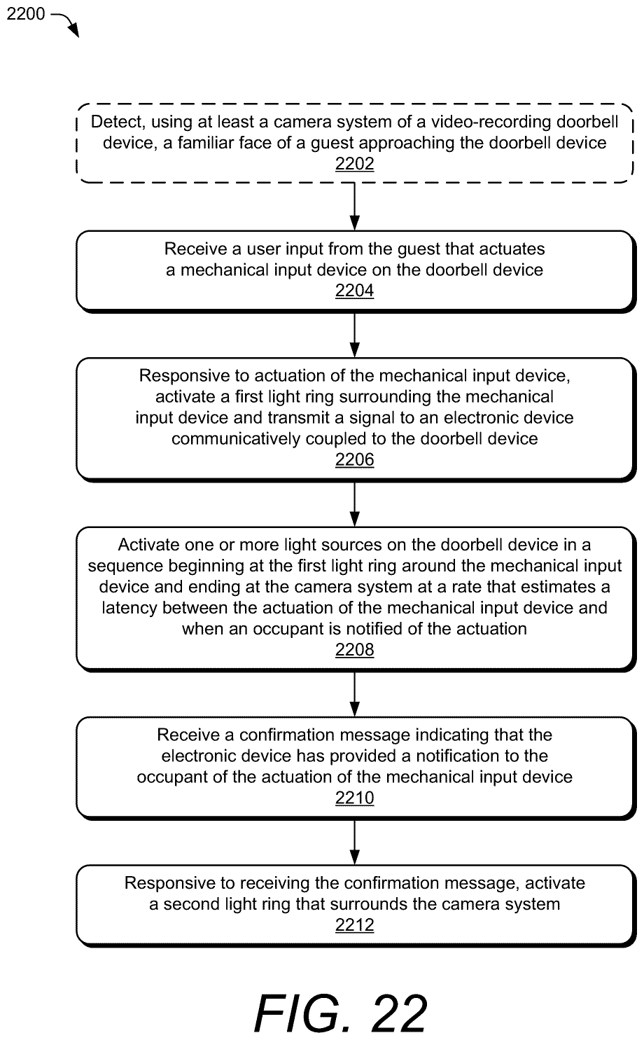

FIG. 22 depicts an example method of providing context-aware notifications. The method 2200 can be performed by the wireless network device 102, uses at least the context sensing module 452 and/or the characterization module 454 to implement the described techniques. The method 2200 provides an enhanced user experience for both an owner of the wireless network device 102 (or occupant of a home on which the wireless network device 102 is installed) and a guest that interacts with the wireless network device 102 (e.g., doorbell device 226).

The method 2200 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. Further, the method 2200 may be combined with and optionally performed in conjunction with the method 2100. In portions of the following discussion, reference may be made to the example environment 100 of FIG. 1 or to entities or processes as detailed in FIGS. 2-21, reference to which is made for example only. The techniques are not limited to performance by one entity or multiple entities operating on one device.

Optionally at 2202, using at least a camera system of a video-recording doorbell device, a familiar face of a guest approaching a doorbell device is detected. For example, using the techniques described herein, the camera system 702 of the doorbell device 226 captures images as the guest approaches the doorbell device 226. The context sensing module 452 detects context data regarding the approaching guest, e.g., based on behavioral characteristics, object recognition, facial recognition, voice recognition, timing information, status of the network environment, and stored user data associated with a user profile of an occupant. Also, the characterization module 454 characterizes the approaching guest into one or more potential categories (e.g., familiar face, authorized person, unauthorized person, mailperson, e-commerce delivery (person or drone), food delivery (person or drone), police officer, firefighter, solicitor, transportation service vehicle, city services personnel).

At 2204, a user input is received from the guest that actuates a mechanical input device on the doorbell device. For example, the guest presses the mechanical input device 706 (e.g., the doorbell button 1804) on the doorbell device 226 to trigger a doorbell chime or other notification to alert the occupant of the guest's presence.

At 2206, responsive to actuation of the mechanical input device, a first light ring surrounding the mechanical input device is activated and a signal is transmitted to an electronic device communicatively coupled to the doorbell device. For example, the first portion 1702-1 of the light channel 1702 is illuminated by activating one or more LEDs associated with the light channel 1702.

At 2208, one or more light sources on the doorbell device are activated in a sequence beginning at the first light ring around the mechanical input device and ending at the camera system at a rate that estimates a latency between the actuation of the mechanical input device and when an occupant is notified of the actuation. For example, the third portion 1702-3 of the light channel 1702 is illuminated by activating one or more additional LEDs associated with the light channel 1702 to create a line of light that visually extends over time from the first portion 1702-1 at the mechanical input device 706 (e.g., doorbell button 1804) toward the camera system 702. The line of light may increase in length at a rate that estimates the time between the actuation of the mechanical input device 706 and when the occupant is provided an alert indicating the guest's presence.

At 2210, a confirmation message indicating that the electronic device provided a notification to the occupant of the actuation of the mechanical input device is received. For example, the wireless network device 102 (e.g., hub 120) inside the building generates a signal (e.g., auditory chime, flashing lights, auditory voice message) to alert the occupant of the presence of the guest. In response to generating the signal for the occupant, the wireless network device 102 transmits the confirmation message to the doorbell device 226 to confirm that the signal has been generated for the occupant. In some aspects, the wireless network device 102 transmits the confirmation message in response to the occupant accessing the video feed being captured by the camera system 702 on the doorbell device 226. As a result, the doorbell device 226 may receive the confirmation message when the occupant accesses the video feed.

At 2212, responsive to receiving the confirmation message, a second light ring that surrounds the camera system is activated. For example, the doorbell device 226 activates the second portion 1702-2 of the light channel 1702 around the camera system 702. Illuminating this light ring around the camera system 702 serves as a notification to the guest that the occupant has been alerted to the presence of the guest. In some aspects, activating the second light ring serves as an indication that the occupant has accessed the video feed being captured by the camera system 702.

Throughout this disclosure examples are described where a computing system (e.g., the doorbell device 226, the wireless network device 102, the smart devices 204, the client device 228, the server system 164 or server device, a computer, or other type of computing system) may analyze information (e.g., radar, inertial, voice sensor data, and facial-recognition sensor data) associated with a guest (e.g., person or drone), such as facial features, body language, apparel, and so forth. The computing system, however, can be configured to only use the information after the computing system receives explicit permission from the user of the computing system to use the data. For example, in situations where the doorbell device 226 analyzes sensor data for facial features to recognize a person known to the user (e.g., family member, close friend, other occupant(s) of the home, the user themself), individual users may be provided with an opportunity to provide input to control whether programs or features of the doorbell device 226 can collect and make use of the data. The individual users may have constant control over what programs can or cannot do with sensor data. In addition, information collected may be pre-treated in one or more ways before it is transferred, stored, or otherwise used, so that personally-identifiable information is removed. For example, before the doorbell device 226 shares sensor data with another device (e.g., to train a model executing at another device), the doorbell device 226 may pre-treat the sensor data to ensure that any user-identifying information or device-identifying information embedded in the data is removed. Thus, a recognized or authorized user (e.g., known to the occupant) may have control over whether information is collected about the recognized or authorized user by the doorbell device 226, and how such information, if collected, may be used by the computing system and/or a remote computing system.

Some examples are described below:

A method for providing context-based options to a guest in proximity to an electronic device associated with a structure, the method comprising: determining, using one or more sensors of the electronic device, one or more characteristics of the guest; determining a context of the guest based on the one or more characteristics; identifying, based on the determined context, a plurality of context-based options that each represent an estimated purpose for a visit by the guest to an occupant of the structure associated with the electronic device; presenting the plurality of context-based options via a user interface displayed by a display device of the electronic device, the plurality of options being selectable by the guest to convey an intent for the guest's visit to the occupant of the structure; receiving a user input from the guest selecting a context-based option from the plurality of context-based options presented via the user interface; and providing a notification associated with the selected context-based option.

The method may further comprise accessing user data associated with a user profile of the occupant and stored at a cloud service, wherein the identifying the plurality of options is based on a combination of the determined context of the guest and the user data of the occupant.

The method may further comprise analyzing the user data associated with the user profile of the occupant to detect whether the occupant is expecting a visit from a particular guest or type of guest.

The user data includes information associated with one or more of a digital calendar, email messages, short message service messages, a social media account, and one or more applications associated with the user profile of the occupant.

The one or more characteristics may include one or more of apparel, a logo on the apparel, a badge, an object being carried by the guest, and facial features of the guest.

The method may further comprise moving the plurality of context-based options across the user interface based on the user input being a swipe or drag gesture.

The context of the guest may define a guest type from a plurality of guest types including a mailperson, a police officer, a solicitor, a familiar face, a homeowner, a generic courier, a food delivery person, or an e-commerce delivery person.

The providing the notification may comprise providing the notification in response to actuation of a mechanical input device on the electronic device.

The user interface may be integrated with the mechanical input device.

The user interface may have an annular shape; and the mechanical input device may be concentrically positioned in a center of the user interface.

One or more of the selectable options may be displayed adjacent to a user input mechanism.

The providing a notification associated with the selected context-based option may include transmitting a message to a wireless network device inside the structure to alert the occupant of a presence of the guest and the intent for the guest's visit.

The method may further comprise recognizing the guest as the occupant, the identifying a plurality of context-based options may include identifying customized context-based options for the occupant; the customized context-based options may include arming or disarming a security system; the user input may include selection of the arming or disarming of the security system; and the providing a notification may include notifying the occupant of a state change of the security system based on the selection.

The plurality of context-based options may include a machine-readable code for the guest to scan using a mobile device of the guest, and the machine-readable code may be configured to: direct the mobile device of the guest to communicate with a server communicatively coupled to the electronic device; and enable the guest to convey the intent of the guest's visit via the mobile device of the guest in a message to the server, which forwards the message to a wireless network device of the occupant.

An electronic device comprising: a camera device configured to capture one or more images of a guest visiting a structure associated with the electronic device; one or more sensors configured to determine one or more characteristics of the guest; a display device configured to present a user interface; a mechanical input device integrated with the display device; and a processor configured to perform the method described above.

A method for communicating a type of guest to a user of an electronic device, the method comprising: detecting a presence of a guest within a sensor detection area of the electronic device; determining information associated with a user profile of the user of the electronic device; estimating one or more types of guest that the user is expecting based on the determined information associated with the user profile; identifying, based on the estimated one or more types, selectable options that each represent a potential purpose for the guest's presence; presenting the selectable options via a display of the electronic device for selection by the guest to enable the guest to indicate a purpose for the guest's presence; receiving a user input that selects one of the selectable options; and providing a notification to another device of the user to indicate the presence of the guest and the purpose for the guest's presence corresponding to the selected option.

The information associated with the user profile of the user may include one or more of a calendar item, a user schedule, an email, an SMS message, and an audio command.

The method may further comprise: determining, using one or more sensors, one or more characteristics of the guest; and determining a context of the guest based on the one or more characteristics, wherein identifying the selectable options is based on a combination of the determined context of the guest and the estimated one or more types of guest that the user is expecting.

A method for providing a context-aware notification to a guest, the method comprising: receiving a user input from a guest that actuates a mechanical input device on a first electronic device; responsive to actuation of the mechanical input device, activating a first light ring surrounding the mechanical input device and transmitting a signal to a second electronic device communicatively coupled to the first electronic device; activating one or more light sources on the first electronic device beginning at the first light ring and ending at a camera system of the first electronic device at a rate that estimates a latency between the actuation of the mechanical input device and a time when a user associated with the second electronic device is notified of the actuation; receiving, at the first electronic device, a confirmation message indicating that the second electronic device has provided a notification to the user of the actuation of the mechanical input device; and responsive to receiving the confirmation message, activating a second light ring that surrounds the camera system.

Optionally, the method may include, prior to receiving the user input from the guest, detecting, using at least an image sensor of the first electronic device, a familiar face of the guest as the guest approaches the first electronic device. The method may also include characterizing the guest into one or more potential categories or types.

The one or more light sources may create a line of light that visually extends over time from the first light ring toward the second light ring. The line of light may increase in length at a rate that estimates the time between actuation of the mechanical input device and when the user associated with the second electronic device is notified of the actuation.

The activating of the second light ring indicates to the guest that the user has been alerted to a presence of the guest.

The activating of the second light ring indicates that the user associated with the second electronic device has accessed a video feed being captured by the image sensor of the first electronic device to view the guest.

The one or more light sources are used to provide a progress indicator that communicates to the guest the latency from the actuation of the mechanical input device and the time when the user is signaled. The one or more light sources may include one or more strips of light that progressively illuminate from a first end (at the mechanical input device) toward a second, opposite end at a rate that corresponds to an estimated latency between the actuation of the mechanical input device and when the user is notified of the actuation.

### CONCLUSION

Although aspects of context-based user interface have been described in language specific to features and/or methods, the subject of the appended claims is not necessarily limited to the specific features or methods described. Rather, the specific features and methods are disclosed as example implementations of the techniques for context-based user interface, and other equivalent features and methods are intended to be within the scope of the appended claims. Further, various different aspects are described, and it is to be appreciated that each described aspect can be implemented independently or in connection with one or more other described aspects.

1. A method for providing context-based options to a guest in proximity to an electronic device associated with a structure, the method comprising:
determining, using one or more sensors of the electronic device, one or more characteristics of the guest;
determining a context of the guest based on the one or more characteristics;
identifying, based on the determined context, a plurality of context-based options that each represent an estimated purpose for a visit by the guest;
dynamically adapting a user interface displayed by a display device of the electronic device by presenting the plurality of context-based options based on the determined context, the plurality of context-based options being selectable by the guest to convey an intent for the guest's visit to an occupant of the structure associated with the electronic device;
receiving a user input from the guest selecting a context-based option from the plurality of context-based options presented via the user interface; and
providing a notification associated with the selected context-based option.

2. The method of claim 1, further comprising accessing user data associated with a user profile of the occupant and stored at a cloud service, wherein the identifying the plurality of context-based options is based on a combination of the determined context of the guest and the user data of the occupant.

3. The method of claim 2, further comprising analyzing the user data associated with the user profile of the occupant to detect whether the occupant is expecting a visit from a particular guest or type of guest.

4. The method of claim 2, wherein the user data includes information associated with one or more of a digital calendar, email messages, short message service messages, a social media account, and one or more applications associated with the user profile of the occupant.

5. The method of claim 1, wherein the one or more characteristics include one or more of apparel, a logo on the apparel, a badge, an object being carried by the guest, and facial features of the guest.

6. The method of claim 1, further comprising moving the plurality of context-based options across the user interface based on the user input being a swipe or drag gesture.

7. The method of claim 1, wherein the context of the guest defines a guest type from a plurality of guest types.

8. The method of claim 7, wherein the plurality of guest types includes a mailperson, a police officer, a solicitor, a familiar face, a homeowner, a generic courier, a food delivery person, or an e commerce delivery person.

9. The method of claim 1, wherein providing the notification comprises providing the notification in response to actuation of a mechanical input device on the electronic device.

10. The method of claim 9, wherein the user interface is integrated with the mechanical input device.

11. The method of claim 10, wherein:
the user interface has an annular shape; and
the mechanical input device is concentrically positioned in a center of the user interface.

12. The method of claim 1, wherein providing a notification associated with the selected context-based option includes transmitting a message to a wireless network device inside the structure to alert the occupant of a presence of the guest and the intent for the guest's visit.

13. The method of claim 1, further comprising recognizing the guest as the occupant, wherein:
the identifying a plurality of context-based options includes identifying customized context-based options for the occupant;
the customized context-based options include arming or disarming a security system;
the user input includes selection of the arming or disarming of the security system; and
the providing a notification includes notifying the occupant of a state change of the security system based on the selection.

14. The method of claim 1, wherein:
the plurality of context-based options include a machine-readable code for the guest to scan using a mobile device of the guest; and
the machine-readable code is configured to:
direct the mobile device of the guest to communicate with a server communicatively coupled to the electronic device; and
enable the guest to convey the intent of the guest's visit via the mobile device of the guest in a message to the server, which forwards the message to a wireless network device of the occupant.

15. An electronic device comprising:
one or more sensors configured to detect a presence of a guest within a sensor detection area of the electronic device;
a display device configured to present a user interface;
a mechanical input device integrated with the display device; and
a processor configured to:
determine information associated with a user profile of a user of the electronic device;
estimate one or more types of guest that the user is expecting based on the determined information associated with the user profile;
identify, based on the estimated one or more types, selectable options that each represent a potential purpose for the guest's presence, the selectable options being less than a total number of available options;
present the selectable options via the user interface for selection by the guest to enable the guest to indicate a purpose for the guest's presence;
receive a first user input that selects one of the selectable options;
receive a second user input that actuates the mechanical input device; and
responsive to actuation of the mechanical input device, provide a notification to another device of the user to indicate the presence of the guest and the purpose for the guest's presence corresponding to the selected option.

16. The electronic device of claim 15, wherein the information associated with the user profile of the user includes one or more of a calendar item, a user schedule, an email, an SMS message, and an audio command.

17. The electronic device of claim 15, wherein the processor is further configured to:
determine, using the one or more sensors, one or more characteristics of the guest; and
determine a context of the guest based on the one or more characteristics, wherein the selectable options are identified based on a combination of the determined context of the guest and the estimated one or more types of guest that the user is expecting.

18. A method for providing a context-aware notification to a guest, the method comprising:
receiving a user input from the guest that actuates a mechanical input device on a first electronic device;
responsive to an actuation of the mechanical input device, activating a first light source proximate to the mechanical input device and transmitting a signal to a second electronic device communicatively coupled to the first electronic device;
activating one or more additional light sources on the first electronic device beginning at the first light source and ending at a camera system of the first electronic device at a rate that estimates a latency between the actuation of the mechanical input device and a time when a user associated with the second electronic device is notified of the actuation;
receiving, at the first electronic device, a confirmation message indicating that the second electronic device has provided a notification to the user of the actuation of the mechanical input device; and
responsive to receiving the confirmation message, activating a second light source proximate to the camera system.

19. The method of claim 18, wherein the one or more additional light sources create a line of line that visually extends over time from the first light source toward the second light source.

20. The method of claim 18, further comprising:
responsive to the actuation of the mechanical input device, activating an image sensor of the first electronic device to capture a video feed, wherein activating the second light source is responsive to the confirmation message also indicating that the user associated with the second electronic device has accessed the video feed being captured by the image sensor of the first electronic device to view the guest.
